(19) United States
(12) Patent Application Publication
(10) Pub. No.: US 2023/0385670 A1
(43) Pub. Date: Nov. 30, 2023

(54) AUXILIARY QUBIT DETECTION IN QUANTUM CIRCUITS

(71) Applicant: Classiq Technologies LTD., Tel Aviv (IL)

(72) Inventors: Eyal Cornfeld, Ramat Gan (IL); Shmuel Ur, Shorashim (IL); Ofek Kirzner, Haifa (IL)

(21) Appl. No.: 17/664,742

(22) Filed: May 24, 2022

(51) Int. Cl. G06N 10/20; G06N 10/70

(52) U.S. Cl. CPC G06N 10/20; G06N 10/70

(57) ABSTRACT

A method, apparatus and product including obtaining a representation of a quantum circuit that manipulates a plurality of qubits over a plurality of cycles, wherein role indications of the plurality of qubits are not available; and detecting one or more robust qubits in the plurality of qubits. Each qubit of the one or more robust qubits comprises a dirty auxiliary qubit that is robust to quantum states of remaining qubits from the plurality of qubits. The detecting includes applying one or more initial states to the plurality of qubits using one or more quantum state setters, simulating the quantum circuit using a simulator, and inspecting states of the plurality of qubits from said simulating.

### TECHNICAL FIELD

The present disclosure relates to quantum computing in general, and to detecting auxiliary qubits utilized in a quantum system, in particular.

### BACKGROUND

Quantum computing is a computational paradigm that is fundamentally different from classic computing. In contrast to classic computing, which utilizes bits, quantum computing utilizes qubits. The qubits have unique features, as each qubit can be in superposition, several qubits can be entangled, and all operations on qubits besides measurement, referred to as quantum gates, must be reversible. Temporarily computed values are stored on additional helper qubits, referred to as auxiliary qubits.

### BRIEF SUMMARY

One exemplary embodiment of the disclosed subject matter is a method comprising: obtaining a representation of a quantum circuit, wherein the quantum circuit manipulates a plurality of qubits over a plurality of cycles, wherein role indications of the plurality of qubits are not available; and detecting one or more robust qubits in the plurality of qubits, wherein each qubit of the one or more robust qubits comprises a dirty auxiliary qubit that is robust to quantum states of remaining qubits from the plurality of qubits, wherein said detecting comprises: applying one or more initial states to the plurality of qubits using one or more quantum state setters, simulating the quantum circuit using a simulator, and inspecting states of the plurality of qubits from said simulating.

Optionally, said detecting comprises applying one or more inverse quantum state setters, wherein the one or more quantum state setters are operatively coupled to the plurality of qubits before being manipulated by the quantum circuit, wherein the one or more inverse quantum state setters are operatively coupled to the plurality of qubits after being manipulated by the quantum circuit, wherein the one or more inverse quantum state setters are configured to reverse the one or more initial states.

Optionally, said detecting comprises generating a detecting quantum circuit, wherein the detecting quantum circuit comprises one or more additional qubits that are external of the quantum circuit, wherein the plurality of qubits excludes the one or more additional qubits.

Optionally, said detecting comprises: pairing the plurality of qubits to the one or more additional qubits, respectively, thereby obtaining a plurality of disjoint qubit pairs, and applying, using the one or more quantum state setters, a maximally-entangled state to each of the plurality of qubit pairs.

Optionally, said detecting comprises, iteratively: selecting computational basis states for the plurality of qubits, respectively, and applying, by the one or more quantum state setters, the computational basis states to each of the plurality of qubit pairs.

Optionally, said detecting comprises generating a testing quantum circuit, wherein the testing quantum circuit is configured to obtain the quantum circuit and the role indications, and to verify unverified qubits that are indicated by the role indications as clean or dirty auxiliary qubits, wherein the testing quantum circuit is configured to perform said simulating and said inspecting.

Optionally, the method comprises iteratively executing the testing quantum circuit for one or more qubits of the plurality of qubits, wherein, in each iteration, the role indications are generated and provided to the testing quantum circuit by indicating that an inspected qubit of the one or more qubits is a dirty auxiliary qubit and that the remaining qubits of the plurality of qubits are argument qubits.

Optionally, said inspecting comprises utilizing a reduced density matrix, measurements, or the like.

Optionally, the method comprises compiling the representation of the quantum circuit based on said detecting the one or more robust qubits.

Optionally, said identifying is performed without iteratively checking each potential subgroup of the plurality of qubits individually.

Optionally, the role indications comprise one or more auxiliary qubit indications indicating one or more unverified qubits within the plurality of qubits of the quantum circuit.

Optionally, a qubit of the plurality of qubits is robust to the quantum states of the remaining qubits in case an auxiliary property is complied with by the qubit for each initial state of the plurality of qubits.

Another exemplary embodiment of the disclosed subject matter is an apparatus comprising a processor and coupled memory, said processor being adapted to: obtain a representation of a quantum circuit, wherein the quantum circuit manipulates a plurality of qubits over a plurality of cycles, wherein role indications of the plurality of qubits are not available; and detect one or more robust qubits in the plurality of qubits, wherein each qubit of the one or more robust qubits comprises a dirty auxiliary qubit that is robust to quantum states of remaining qubits from the plurality of qubits, wherein said detecting comprises: applying one or more initial states to the plurality of qubits using one or more quantum state setters, simulating the quantum circuit using a simulator, and inspecting states of the plurality of qubits from said simulating.

Yet another exemplary embodiment of the disclosed subject matter is a system comprising a processor and coupled memory, said processor being adapted to: obtain a representation of a quantum circuit, wherein the quantum circuit manipulates a plurality of qubits over a plurality of cycles, wherein role indications of the plurality of qubits are not available; and detect one or more robust qubits in the plurality of qubits, wherein each qubit of the one or more robust qubits comprises a dirty auxiliary qubit that is robust to quantum states of remaining qubits from the plurality of qubits, wherein said detecting comprises: applying one or more initial states to the plurality of qubits using one or more quantum state setters, simulating the quantum circuit using a simulator, and inspecting states of the plurality of qubits from said simulating.

Yet another exemplary embodiment of the disclosed subject matter is a computer program product comprising a non-transitory computer readable medium retaining program instructions, which program instructions, when read by a processor, cause the processor to: obtain a representation of a quantum circuit, wherein the quantum circuit manipulates a plurality of qubits over a plurality of cycles, wherein role indications of the plurality of qubits are not available; and detect one or more robust qubits in the plurality of qubits, wherein each qubit of the one or more robust qubits comprises a dirty auxiliary qubit that is robust to quantum states of remaining qubits from the plurality of qubits, wherein said detecting comprises: applying one or more initial states to the plurality of qubits using one or more quantum state setters, simulating the quantum circuit using a simulator, and inspecting states of the plurality of qubits from said simulating.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 illustrates an exemplary flowchart diagram of a method, in accordance with some exemplary embodiments of the disclosed subject matter;

FIG. 2 illustrates exemplary inputs and output characterizations, in accordance with some exemplary embodiments of the disclosed subject matter;

FIG. 3 illustrates exemplary simulators, in accordance with some exemplary embodiments of the disclosed subject matter;

FIG. 4 illustrates an exemplary testing quantum circuit, in accordance with some exemplary embodiments of the disclosed subject matter;

FIG. 5 illustrates an exemplary tensor network, in accordance with some exemplary embodiments of the disclosed subject matter;

FIGS. 6A and 6B illustrate exemplary flowchart diagrams of methods, in accordance with some exemplary embodiments of the disclosed subject matter;

FIG. 7 illustrates exemplary inputs and output characterizations, in accordance with some exemplary embodiments of the disclosed subject matter; and

FIG. 8 illustrates an exemplary detecting quantum circuit, in accordance with some exemplary embodiments of the disclosed subject matter.

### DETAILED DESCRIPTION

One technical problem dealt with by the disclosed subject matter is to improve the quantum circuit compilation process. In some exemplary embodiments, quantum circuits may be designed, programmed or created by a user, a programmer, an operator, or the like, using gate-level programming, using functional-level code, using evolutionary computing techniques such as Quantum Genetic Algorithm (QGA), using genetic algorithms, or the like. In some exemplary embodiments, after an initial quantum circuit is created, it may go through one or more stages, such as a compilation stage, before becoming an executable quantum circuit.

In some exemplary embodiments, the term ‘compiling’, as used herein, may refer to translating, transpiling, or otherwise analyzing a gate-level or functional-level representation of a quantum circuit and generating based thereon an executable quantum circuit. In some exemplary embodiments, the executable quantum circuit may comprise a machine representation that can be executed by a quantum hardware compiler, a logical program circuit that can be executed or simulated by a classic computer or engine, or the like.

In some exemplary embodiments, a circuit may be compiled based on one or more indications of roles of qubits therein, statuses thereof, identities thereof, or the like. For example, qubits may be indicated as auxiliary qubits, non-auxiliary qubits, input qubits, output qubits, or the like. In some cases, the indications may comprise qubit metadata such as whether auxiliary qubits are clean or dirty, an identity of the input qubits, an identity of the output qubits, whether auxiliary qubits are configured to be uncomputed, expected states of one or more qubits, or the like. In some exemplary embodiments, the functionality of the compiler may depend on the indications. In some exemplary embodiments, compilers may not be configured to analyze the indications to check whether they are accurate.

In some exemplary embodiments, in case an indication is not accurate, a functionality of the circuit may be adversely affected. For example, a qubit that is indicated to be an auxiliary qubit, and is not an auxiliary qubit in reality, may be entangled with other qubits, thereby potentially providing erroneous result and not performing as intended. In some cases, it may be desired to ensure that a compiler is provided with accurate inputs.

Another technical problem dealt with by the disclosed subject matter is to verify that qubits indicated as auxiliary qubits are indeed auxiliary qubits. In some exemplary embodiments, given a quantum circuit and a subset of qubits in the circuit that are indicated as auxiliary qubits, it may be desirable to verify whether the subset of qubits are auxiliary qubits. In case an indicated qubit is not an auxiliary qubit, e.g., does not hold auxiliary properties, the qubit could be entangled with other input qubits, which may adversely affect the results.

Yet another technical problem dealt with by the disclosed subject matter is to verify that auxiliary qubits manipulated by a quantum circuit, program, function, or the like, uphold auxiliary properties with respect to the quantum circuit. In some exemplary embodiments, auxiliary qubits may be available for use by a circuit as temporary workspace. In some exemplary embodiments, an auxiliary qubit pool of auxiliary qubits may include clean auxiliary qubits, dirty auxiliary qubits, or the like. In some exemplary embodiments, in case auxiliary qubits are initialized to a known computational basis state such as the |0> state, they may be referred to as ‘clean’ auxiliary qubits. In some exemplary embodiments, in case auxiliary qubits are retained in an unknown state, they may be referred to as ‘dirty’ auxiliary qubits. It is noted that dirty auxiliary qubits may be in a potentially entangled state with other parts of the quantum processor's memory, but may not be entangled with input qubits that are configured to be manipulated by the circuit. In some exemplary embodiments, during compilation of a quantum circuit, the auxiliary qubit pool may be utilized for allocating auxiliary qubits to gates, functional blocks, or the like.

In some exemplary embodiments, a compiler may expect a qubit that is indicated as an auxiliary qubit, and is used or manipulated by a quantum circuit, to uphold one or more auxiliary properties, conditions, or the like. For example, the compiler may expect a qubit that is indicated as an auxiliary qubit to be released at an end of a quantum circuit utilizing the qubit. As another example, the compiler may expect a qubit that is indicated as an auxiliary qubit not to be entangled with the input qubits. In some exemplary embodiments, any quantum circuit utilizing clean or dirty auxiliary qubits, may be expected to restore the known or unknown state of the qubits before termination of the quantum circuit. In some exemplary embodiments, a quantum circuit manipulating an auxiliary qubit may be expected to return a clean disentangled qubit in the case of a clean auxiliary qubit, and to return a dirty disentangled qubit (e.g., disentangled from other input qubits) with a restored state in the case of a dirty auxiliary qubit. For example, a clean initialized auxiliary qubit may be expected to be clean, disentangled, and at ground state prior to being manipulated by a quantum circuit, and at an end of the quantum circuit. As another example, a dirty auxiliary with an unknown state may be expected to be released in the same unknown state.

In some cases, indications of qubits roles may not be trusted, as they may not always be accurate. In case the indications are not accurate, one or more properties associated with auxiliary qubits may not be uphold. For example, qubits that are indicated as auxiliary qubits may be entangled with other input qubits, thereby violating auxiliary properties. As another example, quantum circuits may not release the auxiliary qubits in their expected state. In some exemplary embodiments, it may be desired to verify whether or not the indications are accurate, e.g., whether a qubit denoted as an auxiliary qubit of a circuit, upholds the auxiliary properties.

One technical solution provided by the disclosed subject matter may include utilizing one or more auxiliary verification tests, to determine whether qubits indicated as auxiliary qubits (referred to as ‘unverified qubits’) comply with one or more auxiliary properties. In some exemplary embodiments, one or more auxiliary verification tests may test auxiliary properties of unverified qubits, when being simulated with different states of input qubits. In some exemplary embodiments, auxiliary properties may define that unverified qubits retain their state after being manipulated by a quantum circuit that is being inspected. For example, in case unverified qubits retain their initial states after being manipulated by a quantum circuit for any proper states of input qubits, the unverified qubits may comply with an auxiliary property. In some exemplary embodiments, the term ‘qubit’, as used herein, may refer to one single qubit, or to a group of multiple qubits. In some exemplary embodiments, the quantum circuit that is being inspected, and is configured to manipulate the unverified qubits, may be referred to herein as ‘the quantum circuit’.

In some exemplary embodiments, a testing quantum circuit may be generated to implement an auxiliary verification test. In some exemplary embodiments, a testing quantum circuit may be generated by a testing agent, testing platform, testing code, testing program, or the like, which may be configured to obtain a logical representation of the quantum circuit that is being inspected, and to obtain role indications of input and output qubits of the quantum circuit (e.g., indications of all of the qubits, a portion thereof, or the like).

In some exemplary embodiments, an auxiliary verification test may inspect the quantum circuit and input qubits that are inputted to the quantum circuit. In some exemplary embodiments, the input qubits may belong, according to the role indications, to one or more input classifications, categories, characterizations, or the like, indicating the assumed roles of the inputted qubits. For example, the role indications may indicate, for each qubit, to which input classification it allegedly belongs. In some exemplary embodiments, input classifications may comprise argument input, expected input, auxiliary input, or the like. It is noted that none of the input classifications may be verified, prior to implementing the disclosed subject matter. For example, a classification of input qubits to auxiliary qubits may be an unverified classification, which may not be verified by either of the disclosed auxiliary verification tests when obtained. It is also noted that in some cases, classifications may relate to a circuit or a portion thereof. However, for the clarity of explanation and without limiting the scope of the disclosed subject matter, classifications may be referred below as being characterized with respect to circuits.

In some exemplary embodiments, the argument input classification may refer to input qubits that constitute the logical input to the quantum circuit. For example, in case the quantum circuit is configured to add a state of a qubit A to a state of a qubit B, qubits A and B may belong to the argument input classification. In some cases, the classification to argument input may also include unreleased dirty auxiliary qubits, which may not be released to be used as auxiliary qubits and may store a state of a previous computation that may or may not be utilized by the circuit.

In some exemplary embodiments, the expected input classification may comprise qubits that are expected to be in a specific state prior to running the quantum circuit. In some exemplary embodiments, the expected input classification may comprise input qubits that are expected to be in one or more particular quantum states, such as magic states, ground or zero states (also referred to as ‘zero input qubit’), or the like. For example, quantum circuits may expect or require to obtain one or more zero input qubits, which may comprise qubits in a zero or ground state. In some cases, unreleased clean auxiliary qubits may be indistinguishable from expected input qubits, as they may be expected to have their known clean state, which may or may not be utilized by the quantum circuit. In some cases, qubits in a zero state, that are not be available to be used by the quantum circuit as auxiliary qubits, may belong to the expected input classification. In some exemplary embodiments, the expected input may be subsumed within the argument inputs, and in some cases, the expected input may not constitute a separate classification.

In some exemplary embodiments, the auxiliary input classification may comprise auxiliary qubits that may be available as temporary workspace by the quantum circuit, and may not be part of a quantum function logic flow. For example, auxiliary qubits may comprise qubits that do not store any information relevant to the quantum circuit's output. In some exemplary embodiments, the auxiliary input classification may comprise clean or dirty auxiliary qubits. In some exemplary embodiments, clean auxiliary qubits may comprise auxiliary qubits whose states or values before the quantum circuit are known. In some exemplary embodiments, dirty auxiliary qubits may comprise auxiliary qubits whose states or values before the quantum circuit are unknown; they may be entangled with each other and with any qubit of the testing quantum circuit, except the other input qubits of the quantum circuit (e.g., with argument qubits, with clean auxiliary qubits, or the like).

In some exemplary embodiments, the output qubits that are outputted from the quantum circuit may belong to one or more output classifications, categories, characterizations, or the like, indicating the role of the outputted qubits. For example, the status indications of a circuit may indicate output classifications of the outputted qubits. In some exemplary embodiments, output classifications may comprise a return output classification and an auxiliary output classification. In some exemplary embodiments, the return output classification may comprise qubits that comprise an output state which is different than input states of the logical input of the quantum circuit, as well as any other states (e.g., “junk” states) which may be stored on the quantum circuit's qubits, and may be entangled with the logical input. For example, the return output classification may comprise the logical input qubits, which may be manipulated by the quantum circuit. In some exemplary embodiments, the auxiliary output classification may comprise qubits that are not be part of a quantum function logic flow, and do not store any information that is relevant to the quantum circuit's output. For example, auxiliary output qubits may comprise qubits that were used by the circuit to temporarily store states.

In some exemplary embodiments, in order for unverified qubits to be classified as clean auxiliary qubits, they must not be entangled with argument input or with dirty auxiliary qubits, they must have a known state before the quantum circuit, and must be returned to the same state after the quantum circuit regardless of the states of the argument input or the dirty auxiliary qubits. For example, a clean auxiliary qubit may have a known zero or ground state before being manipulated by the quantum circuit, which must be restored before the circuit terminates. In some exemplary embodiments, in order for unverified qubits to be classified as dirty auxiliary qubits, they must not be entangled with argument input or with clean auxiliary qubits, must have an unknown state before the quantum circuit, and must be returned to the same unknown state after the quantum circuit (e.g., using an uncompute operation to applied gates) regardless of the states of the argument input or the clean auxiliary qubits. In some cases, dirty auxiliary qubits may be entangled with other dirty auxiliary qubits, or with other parts of the quantum processor's memory, without being entangled with the argument input. For example, dirty auxiliary qubits may be entangled with qubits that are used by the testing quantum circuit for testing the quantum circuit (e.g., setters, inspectors, inverse setters, additional qubits, or the like), without being entangled with qubits indicated as argument qubits.

In some exemplary embodiments, a testing quantum circuit may be generated and used to test whether unverified qubits that are manipulated by a quantum circuit uphold an auxiliary property, e.g., whether an obtained quantum circuit releases its unverified qubits in their original states for any proper states of the input qubits. In some exemplary embodiments, proper states of input qubits may refer to providing expected qubits in their expected states and providing clean auxiliary qubits in a known state such as zero states, while any state of argument qubits and dirty auxiliary qubits may be considered proper. In some exemplary embodiments, in case that the unverified qubits or portion thereof are determined to uphold auxiliary traits, properties, or the like, the unverified qubits may be considered to be verified auxiliary qubits, and may be utilized as auxiliary qubits when compiling the quantum circuit.

In some exemplary embodiments, a testing quantum circuit may comprise a quantum circuit, a software, such as a Software Development Kit (SDK), a library, a function module, or the like, which may be configured to test whether unverified qubits uphold auxiliary properties for any proper states of the input qubits. In some exemplary embodiments, the testing quantum circuit may be generated to comprise one or more simulators, simulation platforms, or the like, for simulating the quantum circuit, simulating an inverse of the quantum circuit, or the like. In some exemplary embodiments, the testing quantum circuit may be generated to comprise one or more quantum state setters (‘setters’) for setting initial quantum states of input qubits, inverse quantum state setters (‘inverse setters’) for reversing the initial states that were set by the quantum state setters to final states, inspectors for inspecting the final states of qubits that are outputted from the reverse setters, or the like. For example, the setters may set the initial quantum states prior to the qubits being manipulated by the quantum circuit, while the inverse setters may set the final states after the qubits are manipulated by the quantum circuit. In some exemplary embodiments, the testing quantum circuit may or may not be generated to comprise one or more additional qubits that are external to the inspected circuit.

In some exemplary embodiments, a testing quantum circuit may enable to test, in parallel, unverified qubits that are indicated as clean auxiliary qubits, and unverified qubits that are indicated as dirty auxiliary qubits. In some exemplary embodiments, a testing quantum circuit may enable to test unverified qubits that are indicated as clean auxiliary qubits and dirty auxiliary qubits, in parallel, sequentially, a combination thereof, or the like. In some exemplary embodiments, the testing quantum circuit may test a circuit at one or more stages of the circuit, such as before compilation thereof, during compilation, after compilation, or the like. In many cases, simulating the circuit may not require to execute the circuit. For example, the testing quantum circuit may be generated, created, built, or the like, for testing qubits of a quantum circuit in non-compiled environment or library.

In some exemplary embodiments, different configurations or settings of testing quantum circuits may correspond to different types of simulators. For example, different configurations of a testing quantum circuit may be selected for quantum computing simulators and for classical computing simulators, based on supported states of the simulators, supported inspection mechanism that are supported by each type of simulator, or the like. In some exemplary embodiments, a simulator type for simulating the circuit may be utilized in case it is available, it has been selected by a user, based on heuristics, or the like. In some exemplary embodiments, in case a testing quantum circuit comprises an inverse circuit of the quantum circuit that is being inspected, the inverse circuit may be simulated using the same type of simulator as the inspected quantum circuit. In some cases, a same simulator may be used to simulate the entire testing quantum circuit. In some exemplary embodiments, the inspected circuit may be simulated to obtain the input qubits with their applied initial states that were applied by the setters, to inverse the states of the qubits when outputted from the quantum circuit, from the inverse quantum circuit, or the like, and to inspect the final states of the qubits after the initial states are reversed (‘the final states’). In some cases, instead of inspecting final states of qubits, the testing quantum circuit may be contracted and compared to one or more defined values.

In some exemplary embodiments, the setters may be enabled to set, or apply, one or more types of states, or quantum information to one or more input qubit classifications (as indicated by the states indications). For example, one or more setters may be configured to set qubits in one or more random or determined computational basis states, maximally-mixed states, maximally-entangled states, highly-entangled states, or the like. In some cases, setters may utilize one or more ‘additional qubits’ for setting joint states, performing comparisons, obtaining additional state information, or the like. In some exemplary embodiments, additional qubits may comprise qubits that belong to the testing quantum circuit, but are external to the inspected quantum circuit that is tested by the testing quantum circuit. For example, additional qubits may be utilized when the testing quantum circuit applies maximally-entangled states on pairs of input qubits with additional qubits, thereby providing Bell-pairs.

In some exemplary embodiments, a maximally-mixed state may comprise a quantum state whose density matrix is proportional to the identity matrix. For example, the maximally mixed state on n qubits may constitute an identity matrix normalized by 2ⁿ. In some cases, a maximally-mixed state may comprise a uniform mixture of states in an orthonormal basis. In some exemplary embodiments, a unique maximally-mixed state may exist for any number of qubits, and may be applicable thereto by a setter. In some exemplary embodiments, a maximally-mixed state may be an absolute property of a set qubit, that may not depend on a relationship of the qubit with other qubits (e.g., unlike the entanglement property). For example, a maximally-mixed state may correspond to one or more features disclosed in ‘What is the difference between maximally entangled and maximally mixed states?’, of StackExchange™, available at ‘physics.stackexchange.com/questions/170318/what-is-the-difference-between-maximally-entangled-and-maximally-mixed-states’.

In some exemplary embodiments, a maximally-entangled state may comprise a quantum state which has maximum von Neumann entropy for each bipartition. In some exemplary embodiments, in contrast to the maximally-mixed state, the maximally-entangled state may comprise a relative property of a quantum system that may depend on an entanglement relationship between two qubits. In some exemplary embodiments, a pair of qubits in any computational basis state that is maximally entangled with respect to one another, may be considered to be a maximally-entangled pair. In some exemplary embodiments, a maximally-entangled state may be applied to pairs of qubits by a setter, e.g., thereby obtaining Bell pairs.

In some exemplary embodiments, a highly-entangled state may comprise a high entanglement state that may be measured by any entanglement quality measurer, as disclosed in G. Brennen, An observable measure of entanglement for pure states of multi-qubit systems. Quantum Information and Computation Vol. 3 No. 6 (November 2003), which is hereby incorporated by reference in its entirety for all purposes without giving rise to disavowment. In some exemplary embodiments, a set of qubits with a highly-entangled state between them, may be considered to be a highly-entangled set. In some exemplary embodiments, a highly-entangled state may be applied to one or more qubits by a setter.

In some cases, setters may utilize one or more generators in order to apply states to input qubits. For example, a setter may set a highly-entangled state to a qubit using a random highly-entangled state generator, similarly to the method disclosed in J. Emerson, Random Quantum Circuits and Pseudo-Random Operators: Theory and Applications. Science 302, 2098 (2003), which is hereby incorporated by reference in its entirety for all purposes without giving rise to disavowment. In other cases, any other generator or mechanism may be utilized in order to apply states to one or more input qubit classifications.

In some exemplary embodiments, after settings one or more initial states of input qubits classifications, e.g., of argument input, expected input, auxiliary input, or the like, a simulator may be utilized for simulating the inspected quantum circuit, executing the quantum circuit, simulating the testing quantum circuit, or the like. In some exemplary embodiments, the quantum circuit, or a tensor network, may be generated or simulated by one or more types of simulators. For example, the circuit may be generated by a State Vector (SV) simulator, a Density Matrix (DM) simulator, a quantum computer simulator, or the like. As another example, a tensor network may be generated by a Tensor Network (TN) simulator simulating the quantum circuit. In some exemplary embodiments, the simulated quantum circuit may obtain one or more unverified qubits indicated as clean auxiliary qubits, dirty auxiliary qubits, or the like, in one or more initial states.

In some exemplary embodiments, the testing quantum circuit may be configured to test whether or not the simulated quantum circuit releases the unverified qubits in the same state that was set by the setters (e.g., the state in which the quantum circuit received them), for any proper input. In some exemplary embodiments, this may be done by measuring the final states of the unverified qubits and comparing them to the initial states that were set by the respective setters, by reversing the initial states using inverse setters and verifying that the resulting final states of the unverified qubits are the zero states, by contracting the testing quantum circuit and comparing a result to a predefined value, or the like. In some cases, the inverse setters may be deployed in order to inverse an initial state of a qubit that was applied by a respective setter, thereby obtaining final qubit states. For example, inverse setters may be configured to inverse states of unverified auxiliary qubits, and identify whether their value is zero, which may indicate that their value was fully restored at an end of the circuit simulation. In some exemplary embodiments, for any quantum operation, such as a function, a state, or the like, an inverse operation may exist. For example, inverse operations are described in the Unitary Inversion of Gates section in ‘Quantum logic gate’ entry in Wikipedia, available at ‘en.wikipedia.org/wiki/Quantum_logic_gate’, which is hereby incorporated by reference in its entirety for all purposes without giving rise to disavowment.

In some exemplary embodiments, a state of the outputted qubits may be measured, inspected, estimated, or the like, such as by one or more inspectors of the testing quantum circuit. For example, the states of the qubits that are outputted from the inspected circuit, an inverse circuit thereof, or the like, may be inspected. In case inverse setters were used, the inspection may be performed to states of qubits after applying one or more inverse setters on the qubits. In some exemplary embodiments, unverified qubits may be inspected, to verify that they are returned from the quantum circuit in a same initial state as before being manipulated by the quantum circuit, an inverse circuit, or the like.

In some exemplary embodiments, a state of a qubit may be inspected using one or more methods, such as by inspecting a reduced density matrix thereof, performing contraction of a TN, performing measurements on results of quantum simulators, or the like. In some exemplary embodiments, the inspection of the resulting states of the unverified qubits may be performed once, multiple times, or the like. In some cases, inspecting a state of a qubit may comprise generating the quantum circuit multiple times, and each time sampling the results to obtain statistically significant results. In some cases, inspecting a state of a qubit may comprise generating the quantum circuit once, and performing multiple measurements of the results to obtain statistically significant results. For example, the quantum circuit may be simulated once, and the final states may be measured or inspected multiple times, such as in order to increase a confidence of the inspected qubit states. In some exemplary embodiments, inspecting a state of a qubit may comprise calculating a reduced density matrix of one or more qubits. In some cases, a density matrix of a qubit may indicate the states of a qubit after every manipulation, change or gate operation that is performed on the qubit and affects the qubit. In some exemplary embodiments, a reduced density matrix may comprise a partial trace of the density matrix, e.g., as disclosed in the Reduced Density Matrices section in ‘Quantum entanglement’ of Wikipedia, available at ‘en.wikipedia.org/wiki/Quantum_entanglement’, which is hereby incorporated by reference in its entirety for all purposes without giving rise to disavowment.

In some exemplary embodiments, in case the inspected state of an unverified qubit indicates that the qubit's state has been restored, the qubit may be considered to uphold auxiliary properties at least with respect to the initial states that were applied to the input qubits. In some exemplary embodiments, in case inverse setters were applied, and the inspected state of an unverified qubit is determined to be in a zero state, ground state, or the like, this may indicate that, for the set of input states applied by the setters, the quantum circuit uphold the auxiliary properties. Otherwise, in case the inspected state is not a zero state, the qubit may be determined to violate auxiliary properties. In some exemplary embodiments, in case a qubit upholds auxiliary properties for any proper initial state of the input qubits (including proper expected input states and proper clean auxiliary states), the qubit may be considered a verified auxiliary qubit.

One technical effect obtained by the disclosed subject matter is enabling to verify whether or not qubits that are indicated as auxiliary qubits, uphold auxiliary properties for any proper states of the input qubits. Utilizing one or more entanglement states, mixed states, contractions, or the like, may override the need for assessing effects of every possible proper input states of input qubits on the unverified qubits, thereby saving computational resources, time resources, or the like.

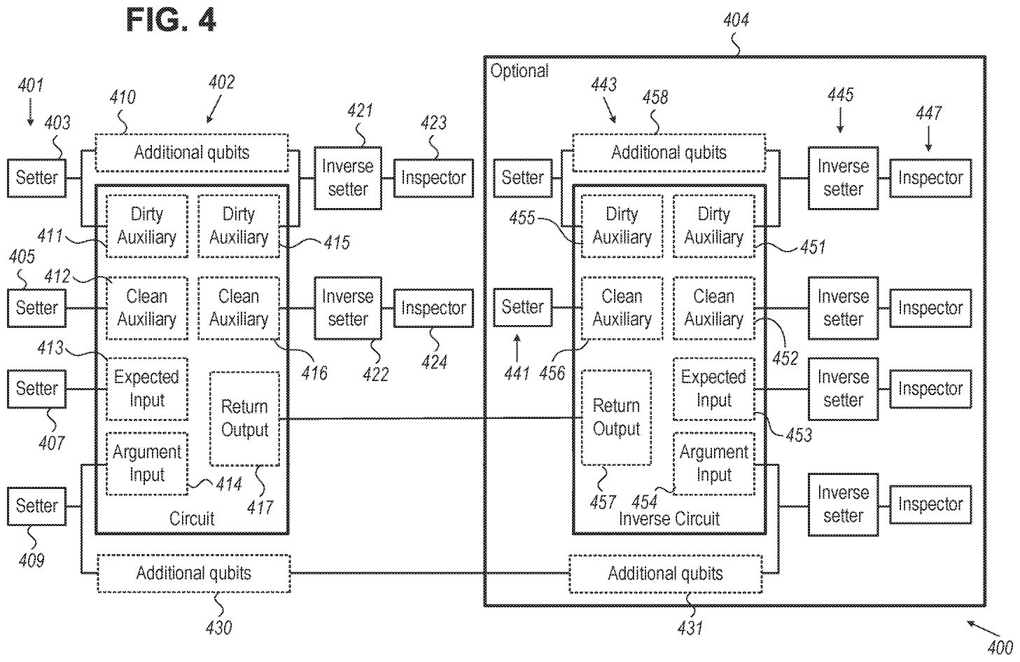

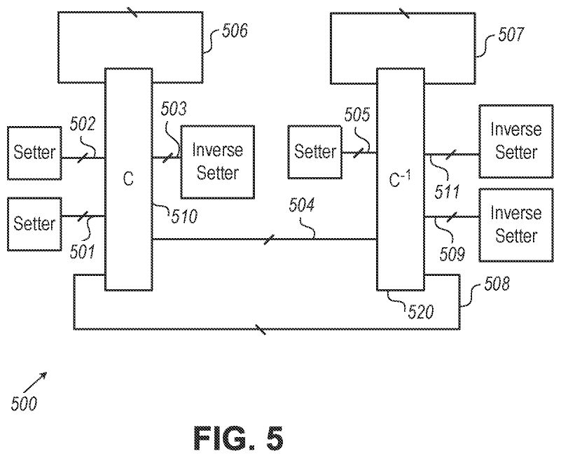

Another technical effect obtained by the disclosed subject matter is providing a testing quantum circuit that enables to verify qubits indicated as clean auxiliary qubits and qubits indicated as dirty auxiliary qubits in parallel, simultaneously, partly simultaneously, or the like, e.g., as depicted in FIGS. 4 and 5.

Yet another technical effect obtained by the disclosed subject matter is enabling a pre-compiler tool to ensure that provided quantum circuits release all of their auxiliaries in the correct state, without spoiling an auxiliary pool. The disclosed testing quantum circuit may also be used for testing that a code of a circuit releases all of its auxiliary qubits as part of a quantum software development stage.

Yet another technical effect obtained by the disclosed subject matter is enabling to manage a resource allocation of an auxiliary pool between different programs, circuits, or the like, by verifying that each program returns its auxiliary qubits in a correct restored state.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

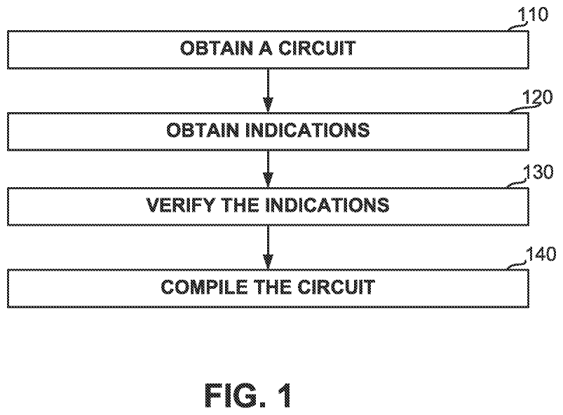

Referring now to FIG. 1, showing an exemplary flowchart diagram of a method, in accordance with some exemplary embodiments of the disclosed subject matter.

On Step 110, a representation of a quantum circuit may be obtained, e.g., from a remote server, a local storage, or the like. For example, the representation of the quantum circuit may comprise or implement one or more quantum programs, functions, computations, or the like, in a logical representation, a gate-level representation, or the like. In some cases, the quantum circuit may be configured to manipulate a plurality of qubits over a plurality of cycles.

On Step 120, indications associated with the quantum circuit may be obtained, e.g., from a remote server, a local storage, or the like. For example, the indications may comprise role indications of inputs and outputs of the quantum circuit. In some exemplary embodiments, the indications may indicate input and output characterizations, classifications, or the like.

In some exemplary embodiments, the indications may comprise one or more auxiliary qubit indications indicating one or more unverified qubits that are manipulated by the quantum circuit as being auxiliary qubits. In some cases, the auxiliary qubit indications may indicate that the unverified qubits manipulated by the circuit comprise one or more auxiliary input qubits, e.g., clean auxiliary qubits, dirty auxiliary qubits, or the like. In some exemplary embodiments, auxiliary qubits may comprise input qubits that are available to be used by the quantum circuit as temporary workspace, and are not part of a logical flow of the circuit. In some exemplary embodiments, auxiliary qubits may comply with one or more auxiliary properties, e.g., a property requiring that qubits should be released from a circuit in a same state in which it was provided to the circuit, a property requiring that a qubit should be disentangled from other input qubits, or the like. In some cases, the auxiliary qubit indications may not be verified. For example, although a qubit may be indicated by the auxiliary qubit indications as an auxiliary qubit, it may in fact not be an auxiliary qubit, not uphold auxiliary properties, or the like.

In some exemplary embodiments, the auxiliary qubit indications may indicate that the unverified qubits comprise dirty auxiliary qubits, clean auxiliary qubits, both, or the like. In some exemplary embodiments, dirty auxiliary qubits may be indicated as an indexed group of one or more qubits, such that the index of each dirty auxiliary input qubit matches the index of its released dirty auxiliary output, thereby providing a mapping of the qubits after and before the circuit manipulation. In some exemplary embodiments, clean auxiliaries may be indicated as an indexed group, such that all groups of qubits which are expected to be in a pure state are indexed within the group, while any recurring pure states may not be indexed. In some cases, for clean qubits in zero or ground state, a direct mapping to the output qubits may not be necessary (e.g., since any clean output qubit in zero state may be mapped thereto).

In some exemplary embodiments, the indications may comprise one or more additional indications, such as an indication of argument input, which may comprise input qubits that constitute a logical input to the quantum circuit. In some exemplary embodiments, the indications may comprise an indication of expected input, which may comprise qubits that are expected by the circuit to be provided in a certain state. In some exemplary embodiments, expected inputs may be expected to have certain states or values, such as a zero state (referred to as ‘zero-input’). In some exemplary embodiments, the indications may comprise output indications, such as indications of return outputs, auxiliary outputs, or the like. It is noted that the indications may not constitute verified indications, and may not necessarily be accurate.

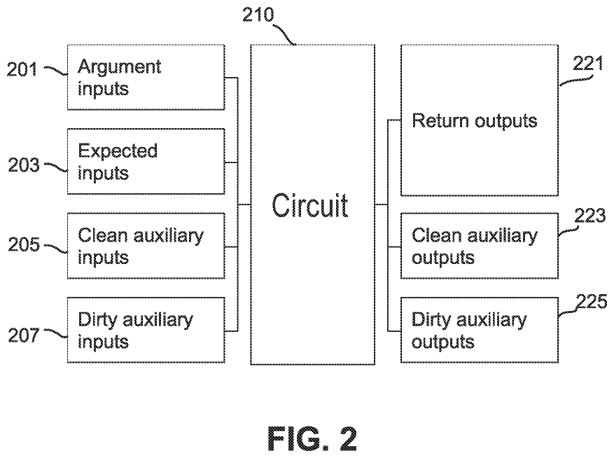

In some cases, the indications may indicate inputs and outputs characterizations of the circuit, e.g., as described in FIG. 2.

Referring now to FIG. 2, depicting exemplary inputs and outputs characterizations of a circuit, in accordance with some exemplary embodiments of the disclosed subject matter.

In some exemplary embodiments, inputs to a quantum circuit, such as Circuit 210, may comprise Argument Inputs 201, Expected Inputs 203, Clean Auxiliary Inputs 205, and Dirty Auxiliary Inputs 207. In some exemplary embodiments, Argument Inputs 201 may comprise qubits that comprise the logical input to Circuit 210. In some exemplary embodiments, Expected Inputs 203 may comprise qubits that are expected to be in a specific state prior to running Circuit 210. In some exemplary embodiments, Clean Auxiliary Inputs 205 may comprise qubit inputs that are not part of a quantum function logic flow, and whose states before Circuit 210 are known. In some exemplary embodiments, Dirty Auxiliary Inputs 207 may comprise qubits that are not part of a quantum function logic flow, and whose states before Circuit 210 are unknown.

In some exemplary embodiments, outputs from Circuit 210 may comprise Return Outputs 221, Clean Auxiliary Outputs 223, Dirty Auxiliary Outputs 225, or the like. In some exemplary embodiments, Return Outputs 221 may comprise qubits that comprise any output which is different than input values of the logical input of Circuit 210. In some exemplary embodiments, Clean Auxiliary Outputs 223 may comprise outputs that are not part of a quantum function logic flow, and whose states after Circuit 210 are known. In some exemplary embodiments, Dirty Auxiliary Outputs 225 may comprise outputs that are not part of a quantum function logic flow, and whose states after Circuit 210 are unknown. For example, Clean Auxiliary Outputs 223 and Dirty Auxiliary Outputs 225 may not store information that is relevant for Circuit 210.

Referring back to FIG. 1, on Step 130, at least a portion of the indications may be verified. In some exemplary embodiments, the auxiliary qubit indications may be tested to determine whether the unverified qubits that are indicated as auxiliary qubits comply with one or more auxiliary properties. In some exemplary embodiments, an auxiliary property may be complied with by the one or more unverified qubits if each of the unverified qubits that is provided to the quantum circuit in a certain state, is outputted from the quantum circuit in the same certain state for any proper states of the qubits. For example, testing the auxiliary qubit indications may include determining whether the unverified qubits uphold auxiliary properties, e.g., whether unverified qubits that are provided to the quantum circuit in a certain state, will always be returned from the quantum circuit in the same certain state, regardless of the states of at least a portion of the remaining qubits.

In some exemplary embodiments, verifying the auxiliary qubit indications may comprise generating a testing quantum circuit based on the quantum circuit. For example, the testing quantum circuit may be configured to test the obtained quantum circuit. In some exemplary embodiments, the testing quantum circuit may be generated to comprise the quantum circuit, the plurality of qubits manipulated by the quantum circuit, and one or more testing components. In some cases, the testing components may comprise one or more quantum state setters for setting initial states to the plurality of qubits, one or more inverse setters for inversing the initial states after the manipulation of the quantum circuit, one or more inspectors, one or more additional qubits, one or more inverse circuits that comprise an inverse of the quantum circuit, or the like.

In some cases, the one or more setters may be operatively coupled to the plurality of qubits before being manipulated by the quantum circuit, while the one or more inverse setters may be operatively coupled to the plurality of qubits after being manipulated by the quantum circuit, thereby reversing the initial states. In some cases, each setter of the one or more setters may be operatively coupled to a set of one or more qubits of the plurality of qubits, which may correspond to one or more input characterizations. For example, a setter may be operatively coupled to argument qubits, to auxiliary qubits, to expected qubits, or the like. In case that an input characterization of a setter comprises an empty set, the setter may not set any state. For example, in case a setter is operatively coupled to expected input, and the plurality of qubits do not comprise any qubit that is indicated as an expected input, the setter may not set any state to any qubit.

In some exemplary embodiments, the one or more quantum state setters may be configured to set, or apply, one or more initial states to one or more respective target qubits that are coupled thereto, e.g., including the plurality of qubits, the one or more unverified qubits, the argument qubits, any other input classifications (if exist), one or more additional qubits, portions thereof, a combination thereof, or the like. In some exemplary embodiments, the one or more target qubits may be manipulated by the testing quantum circuit. In some cases, a setter may be operatively coupled to one or more qubits without setting their states. In such cases, the one or more qubits may not be considered target qubits.

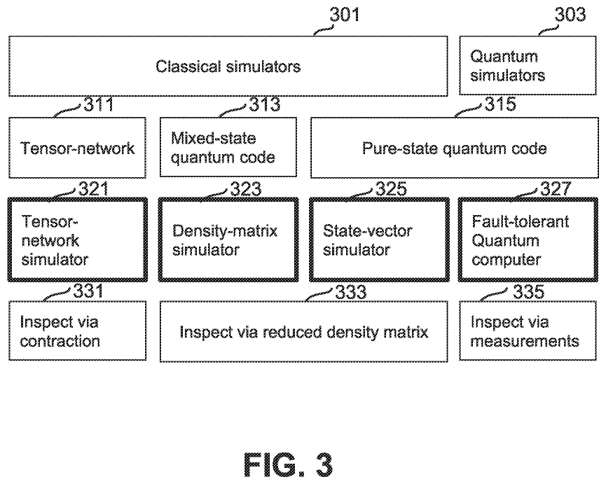

In some exemplary embodiments, the testing quantum circuit may configure a deployed simulator to simulate the quantum circuit (and potentially the inverse circuit) to manipulate the plurality of qubits in their initial states. In some cases, the testing quantum circuit may deploy a simulator such as a SV simulator, a DM simulator, a TN simulator, a quantum simulator such as a fault-tolerant quantum computer, or the like. For example, the simulator may comprise one of the simulators described in FIG. 3.

Referring now to FIG. 3, depicting exemplary simulators, in accordance with some exemplary embodiments of the disclosed subject matter. In some exemplary embodiments, simulators may include Classical Simulators 301, which may be executed on classical computers, or Quantum Simulators 303, which may be executed on quantum simulators, quantum computers, or the like. In some exemplary embodiments, Classical Simulators 301 may enable to execute Tensor Networks 311, Mixed-State Quantum Code 313, and Pure-State Quantum Code 315. In some exemplary embodiments, using Tensor Networks 311, Classical Simulators 301 may enable to execute a Tensor Network Simulator 321.

In some exemplary embodiments, TN simulators may comprise any simulator that supports tensor-network notation, e.g., as disclosed by J. C. Bridgeman & C. T. Chubb, Hand-waving and Interpretive Dance: An Introductory Course on Tensor Networks. J. Phys. A: Math. Theor. 50 223001 (2017), which is hereby incorporated by reference in its entirety for all purposes without giving rise to disavowment. In some exemplary embodiments, a tensor network may include a general computational scheme, which can be used as a simulator. For example, TN simulators may comprise a TN simulator as disclosed in Amazon Braket supported devices, Amazon Web Services, section Tensor Network Simulator (TN1), (2022), available in ‘docs.aws.amazon.com/braket/latest/developerguide/braket-devices.html#braket-simulator-tn1’, which is hereby incorporated by reference in its entirety for all purposes without giving rise to disavowment.

In some exemplary embodiments, using Mixed-State Quantum Code 313, Classical Simulators 301 may enable to execute a Density Matrix Simulator 323. In some exemplary embodiments, DM simulators may comprise any simulator that supports density matrices, e.g., as described in ‘Density matrix’ of Wikipedia, available at ‘en.wikipedia.org/wiki/Density_matrix’, which is hereby incorporated by reference in its entirety for all purposes without giving rise to disavowment. For example, DM simulators may comprise a DM1 simulator as disclosed in Amazon Braket supported devices, Amazon Web Services, section Density Matrix Simulator (DM1), (2022), available in ‘docs.aws.amazon.com/braket/latest/developerguide/braket-devices.html#braket-simulator-dm1’, which is hereby incorporated by reference in its entirety for all purposes without giving rise to disavowment.

In some exemplary embodiments, using Pure-State Quantum Code 315, Classical Simulators 301 may enable to execute a State Vector Simulator 325. In some exemplary embodiments, SV simulators may comprise any simulator that supports state-vectors. For example, SV simulators may comprise an SV1 simulator as disclosed in Amazon Braket supported devices, Amazon Web Services, section State Vector Simulator (SV1) (2022), available in ‘docs.aws.amazon.com/braket/latest/developerguide/braket-devices.html#braket-simulator-sv1’, which is hereby incorporated by reference in its entirety for all purposes without giving rise to disavowment.

In some exemplary embodiments, Quantum Simulators 303 may enable to execute Pure-State Quantum Code 315. In some exemplary embodiments, using Pure-State Quantum Code 315, Quantum Simulators 303 may enable to execute a Fault-Tolerant Quantum Computer 327, or any other quantum simulator. In some exemplary embodiments, a fault-tolerant quantum computer may comprise a type of simulator. For example, a fault-tolerant quantum computer may correspond to one or more features disclosed by ‘Quantum threshold theorem’, of Wikipedia, available at ‘en.wikipedia.org/wiki/Quantum_threshold_theorem’, which is hereby incorporated by reference in its entirety for all purposes without giving rise to disavowment.

In some exemplary embodiments, circuits that a fault-tolerant quantum computer is capable of simulating, may also be simulated by SV simulators, DM simulators, TN simulators, or the like, using the same code. In some exemplary embodiments, circuits that SV simulators are capable of simulating, may also be simulated by DM simulators and TN simulators, using the same code. In some exemplary embodiments, circuits that DM simulators are capable of simulating, may also be simulated by TN simulators, e.g., but not necessarily on the fault-tolerant quantum computer or SV simulators. In some exemplary embodiments, circuits that TN simulators are capable of simulating, may not necessarily be enabled to be simulated by other types of simulators such as SV simulators, DM simulators, and quantum simulators. In some exemplary embodiments, in one or more scenarios, the execution time and memory consumption of Tensor Network Simulator 321 may outperform other simulators.

In some exemplary embodiments, inspectors of the testing quantum circuit may inspect final states of qubits that are outputted from the generated circuit, outputted from an inverse quantum circuit, outputted from inverse setters, or the like, using one or more inspection techniques. In some cases, the final states may correspond to the states of the plurality of qubits or portion thereof after being manipulated by a circuit. In some exemplary embodiments, states of qubits outputted from Tensor Network Simulator 321 may be inspected using Contraction 331. In some exemplary embodiments, states of qubits outputted from the Density Matrix Simulator 323 may be inspected via a Reduced Density Matrix 333, via Measurements 335, or the like. In some exemplary embodiments, states of qubits outputted from State Vector Simulator 325 may be inspected via a Reduced Density Matrix 333, via Measurements 335, or the like. In some exemplary embodiments, states of qubits outputted from Fault-Tolerant Quantum Computer 327 may be inspected via Measurements 335. In some exemplary embodiments, Measurements 335 may be performed by executing or simulating a circuit multiple times, and sampling the states of the qubits after each execution

Referring back to FIG. 1, in some cases, an inverse circuit, including an inverse of the inspected quantum circuit, may be simulated by the testing circuit after the inspected circuit, e.g., as part of a single simulation, as separate simulations, or the like. In some exemplary embodiments, the unverified qubits provided to the inverse circuit may be initialized by one or more second setters, e.g., to the same initial states that were set to the unverified qubits when simulating the quantum circuit, to different initial states, or the like. In some cases, the return output from the quantum circuit may be provided to the inverse circuit. For example, testing quantum circuit may be required to comprise inverse circuits when using TN simulators, e.g., as depicted in FIG. 5. In some cases, the inverse circuit may deploy inverse setters and inspectors to inspect all of the input classifications, such as in order to verify that the states of the qubits are returned, by the inverse circuit, to their original states before the manipulation of the quantum circuit.

In some cases, until a confidence threshold is complied with, the setting of the initial states, the generation of the circuit, and the inspections may be performed iteratively, repeatedly, or the like. In other cases, the setting of the initial states and the generation of the circuit may be performed once, twice, or the like, and the inspections may be performed iteratively, repeatedly, or the like, until a confidence threshold is complied with.

On Step 140, after verifying the inspected quantum circuit by the testing quantum circuit, the inspected quantum circuit may be compiled according to the result of the verification. In some exemplary embodiments, compiling the quantum circuit may result with an executable quantum circuit. In some exemplary embodiments, compiling the quantum circuit may comprise utilizing the one or more unverified qubits, or portion thereof, as auxiliary qubits, in case that the verification process of Step 130 indicates that they uphold auxiliary properties. In some exemplary embodiments, compiling the quantum circuit may comprise not utilizing an unverified qubit as an auxiliary qubit, in case that the verification process of Step 130 indicates that the unverified qubit does not uphold auxiliary properties. For example, some unverified qubits may be verified successfully, and may be used as auxiliary qubits, while other unverified qubits may not be verified successfully, and may not be used as auxiliary qubits of the inspected circuit.

Referring now to FIG. 4, showing an exemplary testing quantum circuit, in accordance with some exemplary embodiments of the disclosed subject matter.

In some exemplary embodiments, Testing Quantum Circuit 400 may comprise an architecture of a quantum circuit implementing an auxiliary verification test. In some exemplary embodiments, Testing Quantum Circuit 400 may comprise an inspected circuit such as Circuit 402, an inverse thereof, one or more additional components for testing and verifying qubits (e.g., external to Circuit 402), or the like. In some exemplary embodiments, given a quantum circuit such as Circuit 402 and a subset of one or more unverified qubits of Circuit 402 that are indicated as auxiliary qubits (Dirty Auxiliary Input 411, Clean Auxiliary Input 412, or both), Testing Quantum Circuit 400 may be utilized, by one or more auxiliary verification algorithms or configurations, to provide a definitive answer to the question of whether or not each qubit in the subset of qubits upholds auxiliary properties. In some exemplary embodiments, Testing Quantum Circuit 400 may be utilized to check whether unverified qubits comply with auxiliary properties, which define that auxiliary qubits must be released from Circuit 402 in a same state that they were provided to Circuit 402, given any proper states of the input qubits. In some exemplary embodiments, providing proper input states to Circuit 402 may comprise providing expected qubits in their expected states and providing clean auxiliary qubits in their expected states, while any state of argument qubits and dirty auxiliary qubits may be considered proper (e.g., unless dirty auxiliary qubits are entangled with other input qubits). In some exemplary embodiments, in case that Circuit 402 maintains the states of the unverified qubits, for every possible proper quantum state of the argument qubits, the unverified qubits may be considered to be verified.

In some exemplary embodiments, Testing Quantum Circuit 400 may comprise multiple Setters 401. In some exemplary embodiments, setters may be used to set initial states to the plurality of qubits, such as according to their input types or characterizations. For example, different types of initial states may be set to each input type. In some exemplary embodiments, Setters 401 may be configured to set initial values or states to respective target qubits inputted to Circuit 402. For example, a Setter 403 may be operatively coupled to Dirty Auxiliary Input 411, Setter 405 may be operatively coupled to Clean Auxiliary Input 412, Setter 407 may be operatively attached to Expected Input 413, and Setter 409 may be operatively coupled to Argument Input 414. In other cases, a single setter may be operatively coupled to one or more types of inputs. In some exemplary embodiments, any of Dirty Auxiliary Input 411, Clean Auxiliary Input 412, Expected Input 413, and Argument Input 414 may comprise an empty set, if no qubits were provided. For example, if none of the qubits are indicated as clean auxiliary qubits, the respective input characterization may be empty.

In some exemplary embodiments, Setters 401 may utilize additional qubits (Additional Qubits 410 and/or Additional Qubits 430), in some implementations, in order to apply states to sets of qubits together (e.g., enabling them to cooperatively represent a single state), enhance a measurement efficiency of states, or the like. In some cases, the additional qubits may comprise testing components of Testing Quantum Circuit 400 that are external to the inspected circuit, e.g., Circuit 402, and are excluded from the plurality of qubits manipulated by Circuit 402, e.g., are not auxiliary qubits, argument qubits, or expected qubits. For example, Circuit 402 may not be configured to directly manipulate Additional Qubits 410 or Additional Qubits 430, and may not be obligated to use Additional Qubits 410 or Additional Qubits 430 for its functionality. In some exemplary embodiments, when used, the number of additional qubits that is used may depend on a verification algorithm or configuration of Testing Quantum Circuit 400 that is being used, the simulator type that is being used, or the like. In some cases, a same setter, Setter 403, may be used for Dirty Auxiliary Input 411 and for Additional Qubits 410, such as in order to apply a maximally-entangled state to disjoint pairs of first and second target qubits. For example, the first target qubit may be comprised by Dirty Auxiliary Input 411, and the second target qubit may be comprised by Additional Qubits 410, thereby providing qubit pairs that each include one additional qubit and one dirty qubit. In some cases, a same setter, Setter 409, may be used for Argument Input 414 and for Additional Qubits 430.

In some exemplary embodiments, a quantum circuit such as Circuit 402 may be configured to obtain qubits with initial states, which may or may not be applied thereto by Setters 401. For example, Circuit 402 may comprise at least one linear matrix defining one or more manipulations, which may be applied on inputted qubits with initial states that were set by Setters 401. In some exemplary embodiments, a simulation of Circuit 402 may manipulate the initial states of one or more of the input qubits. In some exemplary embodiments, after generating Circuit 402, the initial states that were applied by the setters to unverified qubits, may be subsequently removed or reversed by inverse setters, and the resulting final states of the qubits may be inspected, measured, or the like, e.g., to verify that they are in zero state. In some exemplary embodiments, in case the qubits outputted from the inverse setters are in zero state, this may indicate that the value of the unverified qubits has been restored by Circuit 402, and that Circuit 402 returns the qubits in the same states in which they were obtained.

In some exemplary embodiments, Circuit 402 may output qubits that were manipulated thereby, provided thereto, or the like, such as Dirty Auxiliary Output 415, Clean Auxiliary Output 416, Return Output 417, or the like. For example, Dirty Auxiliary Output 415 may comprise the qubits of Dirty Auxiliary Input 411 after being manipulated by Circuit 402, Clean Auxiliary Output 416 may comprise the qubits of Clean Auxiliary Input 412 after being manipulated by Circuit 402, and Return Output 417 may comprise the qubits of Expected Input 413 and Argument Input 414 after being manipulated by Circuit 402.

In some exemplary embodiments, inverse setters may be applied to the unverified qubits, e.g., Dirty Auxiliary Output 415, Clean Auxiliary Output 416, or the like, such as in order to reverse the initial states that were set to them by Setters 401 and detect whether the final states of the unverified qubits outputted from the inverse setters are zero states (or whether the network contracts to a defined value). In some cases, Inverse Setter 421 may be operatively coupled to Dirty Auxiliary Output 415, and Inverse Setter 422 may be operatively coupled to Clean Auxiliary Output 416. In other cases, any other inverse setters may be used for reversing states of Dirty Auxiliary Output 415 and Clean Auxiliary Output 416, e.g., in parallel, sequentially, or the like.

In some exemplary embodiments, one or more types of inspections may be applied to inspect states of the unverified qubits. In some exemplary embodiments, final states of qubits outputted from one or more inverse setters may be inspected using one or more inspectors of Testing Quantum Circuit 400. For example, Inspector 423 may be applied to inspect the final states of qubits outputted from Inverse Setter 421, e.g., of dirty auxiliary qubits, and Inspector 424 may be applied to inspect the final states of qubits exiting Inverse Setter 422, e.g., of clean auxiliary qubits. The inspections of Inspectors 423 and 424 may be performed simultaneously, sequentially, a combination thereof, or the like. In some exemplary embodiments, types of inspectors associated to respective types of inspections may be selected to be used by Testing Quantum Circuit 400 based on a type of simulator that is used to simulate Circuit 402, based on an algorithm that is being used and defines inspection configurations, or the like. In some cases, a same type of inspector may be enabled to implemented two or more inspection types. In some cases, inspection types may comprise performing measurements, inspecting reduced density-matrices, performing contractions of tensor networks, or the like. For example, Inspectors 423 and 424 may inspect final states of qubits outputted from Inverse Setters 421 and 422, e.g., using one or more measurements. According to this example, Inspectors 423 and 424 may measure the final states to verify that they are zero states, e.g., indicating that the unverified qubits are released in their initial (original) states. In some cases, the measurements may comprise sampling final states repeatedly for every generation of Circuit 402, an inverse circuit thereof, Testing Quantum Circuit 400, or the like, or for a single generation thereof, until reaching a statistically-based confidence threshold of the measured final states, e.g., using Bayesian inference. As another example, Inspectors 423 and 424 may inspect states of qubits outputted from Inverse Setters 421 and 422 using one or more reduced density matrices. In such cases, Inspectors 423 and 424 may calculate or obtain the reduced density-matrix of the unverified qubits outputted from Inverse Setters 421 and 422, and verify that they are zero states. As another example, in case of simulating Circuit 402 using an TN simulator, a contraction may be used to inspect states of qubits at one or more stages of the tensor network, such as before and after being manipulated by Inverse Setters 421 and 422, by Circuit 402, by an inverse circuit, or the like. In such cases, the inspections may comprise loop contractions (e.g., as disclosed in FIG. 5). In some cases, inspectors that do not comprise loop contractions, may comprise a contraction with the zero state, which may be applied on the qubits that are coupled to such inspectors. In some cases, the inspectors may ensure that a fully contracted tensor-network implementing Testing Quantum Circuit 400 equals to the value of 2^{(sum over all loops of #[qubits in the loop])}, wherein #[qubits in the loop] denotes the number of qubits in the loop.

Referring now to FIG. 5 illustrating an exemplary tensor network, in accordance with some exemplary embodiments of the disclosed subject matter. In some exemplary embodiments, Tensor Network 500 may correspond to Testing Quantum Circuit 400 (FIG. 4) in a scenario in which a tensor simulator is used to simulate an inspected circuit. In some exemplary embodiments, Tensor Network 500 may apply one or more setters to Clean Auxiliary Qubits 501 and Expected Input Qubits 502 of Circuit 510 (e.g., corresponding to Setters 405 and 407 of FIG. 4). In some exemplary embodiments, one or more loop setters including a loop contraction may connect the Argument Input Qubits 508 of Circuit 510 to an output of an inverse circuit of Circuit 510, e.g., Inverse Circuit 520. In some exemplary embodiments, one or more loop setters including a loop contraction may connect the Dirty Auxiliary Input 506 entering Circuit 510 to an output of Circuit 510. In some exemplary embodiments, the Return Output 504 may be provided to Inverse Circuit 520. In some exemplary embodiments, an inverse setter (e.g., corresponding to Inverse Setter 422 of FIG. 4) may be applied to Clean Auxiliary Qubits 503, which may comprise Clean Auxiliary Qubits 501 after being manipulated by Circuit 510, thereby reversing the states that were set to Clean Auxiliary Qubits 501 by the respective setter.

In some exemplary embodiments, Tensor Network 500 may utilize an Inverse Circuit 520 comprising an inverse of Circuit 510. In some exemplary embodiments, Inverse Circuit 520 may be simulated subsequently to Circuit 510. In some exemplary embodiments, Inverse Circuit 520 may obtain Return Output 504 from Circuit 510, as an input to Inverse Circuit 520. In some exemplary embodiments, Inverse Circuit 520 may obtain Argument Input Qubits 508 from Circuit 510, as an output of Inverse Circuit 520. In some exemplary embodiments, a setter of Inverse Circuit 520 may set Clean Auxiliary Qubits 505 that are inputted to Inverse Circuit 520. In some exemplary embodiments, the Dirty Auxiliary Input 507 of Inverse Circuit 520 may not be set by a conventional setter, in contrast to FIG. 4, but rather may be set by a loop setter that comprises a loop contraction connecting dirty auxiliary qubits entering Inverse Circuit 520 to an output of Inverse Circuit 520. In some exemplary embodiments, Inverse Circuit 520 may output Clean Auxiliary Qubits 509 and Expected Input Qubits 511, which may be inversed by inverse setters. In some exemplary embodiments, states of qubits outputted from the inverse setters may be inspected by one or more inspections, contractions, or the like.

Referring back to FIG. 4, Testing Quantum Circuit 400 may utilize, in some cases, an Inverse Structure 404 which may comprise an inverse circuit of Circuit 402, e.g., Inverse Circuit 443. In some exemplary embodiments, Inverse Structure 404 may enable Testing Quantum Circuit 400 to provide additional data regarding the states of the auxiliary qubits, to reduce the number of executions that are required for complying with a confidence threshold of the inspected qubit states, or the like. For example, Circuit 402 may comprise a linear matrix, and Inverse Circuit 443 may comprise its inverse matrix. In some exemplary embodiments, Inverse Circuit 443 may obtain, as inputs, qubit classes corresponding to the qubits exiting Circuit 402, e.g., Dirty Auxiliary Output 455, Clean Auxiliary Output 456, and Return Output 457, and output qubit classes corresponding to the qubits entering Circuit 402, thereby reversing Circuit 402. In some exemplary embodiments, Return Output 457 may comprise the qubits of Return Output 417, which may be coupled or provided as an input to Inverse Circuit 443, to be manipulated thereby. In some exemplary embodiments, one or more setters may be coupled to Dirty Auxiliary Output 455 and Clean Auxiliary Output 456, and may be used to set their initial states. For example, Dirty Auxiliary Output 455 and Clean Auxiliary Output 456 may be set by Setters 441. In some exemplary embodiments, it is noted that although Inverse Circuit 443 may be subsequent to Circuit 402, Setters 441 may not be linked to attached to the inspectors of Circuit 402 (Inspectors 423 and 424), and may not necessarily be performed in a subsequent timeframe. It is further noted that the qubits of Dirty Auxiliary Output 455 and Clean Auxiliary Output 456 may not necessarily comprise qubits that were manipulated or provided to Circuit 402. For example, Setters 441 may set states of qubits that were not manipulated by Circuit 402, and may be implemented before the inspection of Inspectors 423 and 424 is performed, or in any other timeframe such as after the inspection, simultaneously, or the like. In other cases, Setters 441 may set the same qubits that were manipulated by Circuit 402, and may be implemented after the inspection of Inspectors 423 and 424 is performed.

In some exemplary embodiments, Inverse Circuit 443 may be generated, executed, or the like, by one or more simulators, such as by the simulator that was used for simulating Circuit 402, Testing Quantum Circuit 400, or by any other simulator. For example, Inverse Circuit 443 may be simulated using a same simulator type that was used to simulate Circuit 402 as part of a single simulation, as separate simulations, as part of a simulation of the entire testing quantum circuit, or the like. In some exemplary embodiments, Inverse Circuit 443 may manipulate at least one of Dirty Auxiliary Output 455, Clean Auxiliary Output 456, and Return Output 457, using an inverse matrix of Circuit 402, thereby reversing the manipulations of Circuit 402. In some exemplary embodiments, Inverse Circuit 443 may output manipulated states of Dirty Auxiliary Input 451, Clean Auxiliary Input 452, Expected Input 453, and Argument Input 454, which may or may not correspond to the initial states of the input qubits of Circuit 402, e.g., since the manipulations of Circuit 402 are reversed. In some exemplary embodiments, Inverse Circuit 443 may or may not be generated with one or more additional qubits of Testing Quantum Circuit 400 such as Additional Qubits 458 and Additional Qubits 431 (e.g., corresponding to Additional Qubits 410 and Additional Qubits 430). In some exemplary embodiments, Inverse Setters 445 may be applied on Dirty Auxiliary Input 451, Clean Auxiliary Input 452, Expected Input 453, and Argument Input 454, thereby providing final states, and one or more Inspectors 447 may be applied on the qubits exiting Inverse Setters 445, such as in order to measure or inspect their final states. In some exemplary embodiments, in case Inverse Circuit 443 is implemented, the final states that are inspected by the inspectors may refer to final states of qubits existing Inverse Circuit 443, Circuit 402, or both.

In some exemplary embodiments, Testing Quantum Circuit 400 may enable one or more verification algorithms to be implemented using various types of simulators, e.g., SV simulators, DM simulators, quantum computer simulators, or TN simulators, which may be configured to simulate Circuit 402, Inverse Circuit 443, the entire testing quantum circuit, or the like. In some exemplary embodiments, each verification algorithm may correspond to a selection of one or more settings, configurations, or the like, of Setters 401, of Setters 441, of a simulator type, a selection as to whether or not to utilize Inverse Structure 404, a selection as to whether or not to utilize additional qubits, or the like. In some exemplary embodiments, some verification algorithms may require a repeated generation of the quantum circuit, the inverse circuit, or the like, each time with different settings, such as in order to comply with a confidence threshold of the result, in order to ensure that auxiliary properties are complied with, or the like. In some exemplary embodiments, some implementations may not admit, or support, Inverse Structure 404, while in others, the use Inverse Structure 404 may be mandatory. For example, in some cases, when implementing an algorithm utilizing a TN simulator, the use of Inverse Structure 404 may be mandatory, while implementing an algorithm that sets one or more maximally-mixed states may not support the usage of Inverse Structure 404. In some exemplary embodiments, a configuration of setters, inverse setters, and inspectors may only be implemented if one or more types of simulators that are being deployed support or allow such configuration.

In some exemplary embodiments, one or more verification algorithms may comprise respective configurations of Setter 403, which may be applied to qubits that are operatively coupled to Setter 403 or portion thereof (‘target qubits’). In some exemplary embodiments, a first applicable configuration of Setter 403 may be as follows:
1. Select a computational basis.
2. Set computational basis states on the target qubits.
3. Repeat process for all computational bases.

In some exemplary embodiments, according to this configuration, Setter 403 may be enabled to apply a computational basic state of choice to Additional Qubits 410 and/or Dirty Auxiliary Input 411, and repeatedly select and apply all possible computational basis states on the target qubits, in order to ensure that the unverified qubits do not violate the auxiliary property for any selection of a computational basis state. Setter 403 may obtain a selection of computational basic states for each iteration, or independently select a computational basic state using a random generation, heuristics, or the like. In some exemplary embodiments, this configuration of Setter 403 may be applicable for any selection of simulator types for simulating Circuit 402, e.g., SV simulators, DM simulators, quantum computer simulators, or TN simulators, and may support any of these simulators. In some exemplary embodiments, the first applicable configuration of Setter 403 may or may not be applied in a configuration that utilizes Inverse Structure 404.

In some exemplary embodiments, a second applicable configuration of Setter 403 may be as follows:
1. Set a highly-entangled state on all qubits of Dirty Auxiliary Input 411.
2. Repeat process by randomly applying highly-entangled states until complying with a confidence threshold.

In some exemplary embodiments, the second applicable configuration of Setter 403 may be applicable when Additional Qubits 410 are not used, or comprise an empty set. In some exemplary embodiments, the second applicable configuration of Setter 403 may support any simulator type, e.g., SV simulators, DM simulators, quantum computer simulators, or TN simulators, and may be applied when any of these simulators are used. In some cases, highly-entangled states may be applied on Dirty Auxiliary Input 411 until complying with a confidence threshold of choice, which may be based on Bayesian inference. For example, a confidence threshold may correspond to a confidence of a measurement of a qubit state. In some exemplary embodiments, the second applicable configuration of Setter 403 may or may not be applied in a configuration that utilizes Inverse Structure 404.

In some exemplary embodiments, a third applicable configuration of Setter 403 may be as follows:
1. Select any number or quantity of Additional Qubits 410.
2. Set a highly-entangled state on all qubits of Dirty Auxiliary Input 411 and of the selected additional qubits.
3. Repeat the process randomly by applying highly-entangled states on the dirty auxiliary qubits and the selected additional qubits until complying with a confidence threshold.

In some exemplary embodiments, the third applicable configuration of Setter 403 may correspond to the second applicable configuration, in a scenario in which one or more qubits of Additional Qubits 410 are used, in which Additional Qubits 410 is not an empty set, or the like. In some exemplary embodiments, the third applicable configuration of Setter 403 may support any selection of simulator type, e.g., SV simulators, DM simulators, quantum computer simulators, or TN simulators. In some exemplary embodiments, the third applicable configuration of Setter 403 may or may not be applied in a configuration that utilizes Inverse Structure 404.

In some exemplary embodiments, a fourth applicable configuration of Setter 403 may be as follows:
1. Pair each qubit of Dirty Auxiliary Input 411 with a unique additional qubit from Additional Qubits 410.
2. Set a maximally-entangled state on each pair.

In some exemplary embodiments, the fourth applicable configuration of Setter 403 may be applicable only when Additional Qubits 410 are used. In some exemplary embodiments, the fourth applicable configuration of Setter 403 may comprise pairing each dirty auxiliary qubit with a different additional qubit, and applying maximally-entangled states on the qubit pairs. In some exemplary embodiments, the fourth applicable configuration of Setter 403 may be applicable for any selection of simulator type, e.g., SV simulators, DM simulators, quantum computer simulators, or TN simulators. In some exemplary embodiments, the fourth applicable configuration of Setter 403 may or may not be applied in a configuration that utilizes Inverse Structure 404.

In some exemplary embodiments, a fifth applicable configuration of Setter 403 may be as follows:
1. Set a loop contraction between a coupled qubit input to its qubit output.

In some exemplary embodiments, the fifth applicable configuration of Setter 403 may be applicable for TN simulators. In some exemplary embodiments, according to this configuration, TN simulators are used to simulate Circuit 402, and Setter 403 may represent (or be replaced with) a loop setter that comprises a loop contraction, tensor, or the like, which may be deployed between input qubits and their output, such as between Dirty Auxiliary Input 411 and Dirty Auxiliary Output 415. In some cases, when implementing the fifth applicable configuration, inverse setters such as Inverse Setters 421 and 422 may represent loop inverse setters comprising loop contractions, Inspectors such as Inspectors 423 and 424 may comprise loop contractions, or the like. In some exemplary embodiments, the fifth applicable configuration of Setter 403 may be applied, e.g., only, in a configuration that utilizes Inverse Structure 404, after which final states of clean and dirty auxiliary qubits may be inspected.

In some exemplary embodiments, one or more verification algorithms may comprise respective configurations of Setter 409. In some exemplary embodiments, Setter 409 may be capable of applying states to Argument Input 414, to Additional Qubits 430 (if not an empty set), a portion thereof, or the like. In some exemplary embodiments, Setter 409 may be capable of applying all of the states that Setter 403 is capable of applying, but with respect to Argument Input 414 and/or Additional Qubits 430 instead of Dirty Auxiliary Input 411 and/or Additional Qubits 410, respectively: the first applicable configuration, the second applicable configuration, the third applicable configuration, the fourth applicable configuration, and the fifth applicable configuration. For example, Setter 409 may be capable of applying all computational basic states to Argument Input 414 and/or Additional Qubits 430, for any type of simulator. As another example, Setter 409 may be capable of applying a highly-entangled state to Argument Input 414 and/or Additional Qubits 430, for any type of simulator. As another example, Setter 409 may be capable of applying a maximally-entangled state to Argument Input 414 and/or Additional Qubits 430, for any type of simulator. In case of a TN simulator, Setter 409 may comprise a loop contraction.

In some exemplary embodiments, Setter 409 may be capable of applying one or more configurations that are not enabled by Setter 403. In some exemplary embodiments, a sixth applicable configuration of Setter 409 may be as follows:
1. Set a maximally-mixed state on qubits of Argument Input 414.

In some exemplary embodiments, the sixth applicable configuration of Setter 409 may be applicable for DM simulators and TN simulators. In some exemplary embodiments, the sixth applicable configuration of Setter 409 may comprise setting maximally-mixed states on Argument Input 414. In some exemplary embodiments, the sixth applicable configuration of Setter 409 may not be applied in a configuration that utilizes Inverse Structure 404.

In some exemplary embodiments, one or more verification algorithms may comprise respective configurations of Setters 405 and 407. In some exemplary embodiments, Setters 405 and 407 may be configured to set one or more states or values to Clean Auxiliary Input 412 and Expected Input 413, respectively, without being attached or coupled to any additional qubits of Testing Quantum Circuit 400. In some cases, for each qubit of Clean Auxiliary Input 412 and Expected Input 413, Setters 405 and 407 may set the qubit to their expected state. For example, Setter 405 may be configured to set every qubit of Clean Auxiliary Input 412 to a zero state, a ground state, or the like. As another example, Setter 407 may be configured to set every qubit of Expected Input 413 to its expected state.

In some exemplary embodiments, each verification algorithm may comprise a selection of an inspection type. In some exemplary embodiments, each inspection type may comprise an inspecting mechanism implemented at an inspector. In some exemplary embodiments, the inspector may set the inspecting mechanism on attached qubits, that are provided thereto. In some exemplary embodiments, a first inspection type may comprise a measurement mechanism, e.g., as follows:
1. Measure provided qubits.
2. Check that the qubits are in zero state.
3. Perform repeatedly until complying with a confidence threshold.
   In some exemplary embodiments, the first inspection type may be applicable for any simulator type being used to simulate Circuit 402, e.g., SV simulators, DM simulators, quantum computer simulators, or TN simulators.

In some exemplary embodiments, a second inspection type may comprise a reduced density matrix mechanism, e.g., as follows:
1. Calculate a reduced density-matrix of the provided qubits.
2. Check that the qubits are in zero state.
   In some exemplary embodiments, the second inspection type may be applicable for SV simulators, DM simulators, and TN simulators.

In some exemplary embodiments, a third inspection type may comprise a contraction mechanism, e.g., as follows:
1. Replace inspectors that do not comprise a loop contraction, with inspectors that comprise a contraction with the zero state on the qubits that are coupled to the inspectors.
2. Check that the fully contracted tensor-network equals to 2^{(sum over all loops of #[qubits in the loop])}, wherein #[qubits in the loop] denotes the number of qubits in the loop.
   In some exemplary embodiments, the third inspection type may be applicable for TN simulators.

In some exemplary embodiments, each verification algorithm may comprise a selection of setter configuration, a selection of an inspection types, or the like. For example, a verification algorithm may comprise a selection of a configuration of Setter 403, a selection of a configuration of Setter 405, a selection of a configuration of Setter 407, a selection of a configuration of Setter 409, or the like. In some cases, setter configurations may be selected only for Setters 403 and 409, at least since Setters 405 and 407 may be configured to apply only expected states. In some exemplary embodiments, any combination of setter configurations may be selected, unless they contradict a type of simulator that is being used, a type of inspection that is selected, or the like. For example, in case a quantum simulator is being used to simulate Circuit 402, the fourth, fifth and sixth applicable configurations of the setters may be invalid, may not be applicable, or the like.

Different verification algorithms may optimize on one or more parameters. In some exemplary embodiments, in some cases, a tradeoff may exist between memory resources used by a verification algorithm and an execution time of the verification algorithm. For example, a verification algorithm utilizing more additional qubits may result with less execution time, when using certain states (e.g., when applying a highly-entangled state on disjoint qubit pairs). In some cases, a verification algorithm may optimize on both the execution time and the memory resource parameters. For example, one or more verification algorithms that utilize a TN simulator (e.g., the fifth applicable configuration) may optimize on both parameters.

An exemplary verification algorithm may comprise a selection of configurations of Testing Quantum Circuit 400 when utilizing a quantum simulator (referred to as the ‘quantum algorithm’), e.g., as follows:
1. Set a maximally-entangled state at Setter 403.
2. Set a maximally-entangled state at Setter 409
3. Set expected states at Setters 405 and 407.
4. Use a measurement mechanism for inspection.
5. Implement Inverse Structure 404.

In some exemplary embodiments, the quantum algorithm may comprise implementing the fourth applicable configuration of Setter 403, such as by pairing each qubit of Dirty Auxiliary Input 411 with a unique additional qubit from Additional Qubits 410, and setting a maximally-entangled state on each pair. In some exemplary embodiments, the quantum algorithm may comprise implementing the fourth applicable configuration also by Setter 409, such as by pairing each qubit of Argument Input 414 with a unique additional qubit from Additional Qubits 430, and setting a maximally-entangled state on each pair. In some exemplary embodiments, the quantum algorithm may comprise Setter 407 setting expected states to Expected Input 413, and Setter 405 setting zero states to Clean Auxiliary Input 412. In some exemplary embodiments, after generating Circuit 402 using the quantum simulator, the quantum algorithm may comprise implementing the measurement mechanism of the first inspection type, such as by measuring Dirty Auxiliary Output 415 and Clean Auxiliary Output 416 via Inspectors 423 and 424, and checking that the qubits are in zero state. The inspection may be repeated until a confidence threshold is complied with, e.g., using the first simulation of Circuit 402, without performing a second simulation of Circuit 402. According to the quantum algorithm, Inverse Structure 404 may be implemented as well, such as in order to decrease the number of necessary measurements. In other cases, the Inverse Structure 404 may not be implemented.

Another exemplary verification algorithm may comprise a selection of configurations of Testing Quantum Circuit 400 when utilizing an SV simulator (referred to as ‘the SV algorithm’), e.g., as follows:
1. Set a highly-entangled state at Setter 403.
2. Set a highly-entangled state at Setter 409.
3. Set expected states at Setters 405 and 407.
4. Use a reduced density matrix mechanism for inspection.
5. Implement Inverse Structure 404.

In some exemplary embodiments, according to the SV algorithm, Setter 403 may set a highly-entangled state using the second or third applicable configuration of Setter 403. For example, Setter 403 may be implemented by selecting a number of Additional Qubits 410 to be used (or none), and repeatedly setting a highly-entangled state on all qubits of Dirty Auxiliary Input 411 and of the selected additional qubits (if any). In some exemplary embodiments, the SV algorithm may comprise implementing the second or third applicable configuration also by Setter 409. For example, Setter 409 may be implemented by selecting a number of Additional Qubits 430 to be used (or none), and repeatedly setting a highly-entangled state on all qubits of Argument Input 414 and of the selected additional qubits. In some exemplary embodiments, the SV algorithm may comprise Setter 407 setting expected states to Expected Input 413, and Setter 405 setting zero states to Clean Auxiliary Input 412. In some exemplary embodiments, after generating Circuit 402 using the SV simulator, the SV algorithm may comprise implementing the reduced density-matrix mechanism of the second inspection type, such as by calculating a reduced density-matrix for Dirty Auxiliary Output 415 and Clean Auxiliary Output 416, and inspecting the states of the reduced density-matrices via Inspectors 423 and 424, to verify that the qubits are in zero state. In other cases, measurements may be used for the inspection. According to the SV algorithm, steps of Inverse Structure 404 may be implemented as well, such as in order to decrease the number of necessary inspections of the density-matrix. In other cases, the Inverse Structure 404 may not be implemented.

Another exemplary verification algorithm may comprise a selection of configurations of Testing Quantum Circuit 400 when utilizing a DM simulator (referred to as ‘the DM algorithm’), e.g., as follows:
1. Set a highly-entangled state at Setter 403.
2. Set a maximally-mixed state at Setter 409
3. Set expected states at Setters 405 and 407.
4. Use a reduced density matrix mechanism for inspection.

In some exemplary embodiments, according to the DM algorithm, Setter 403 may set a highly-entangled state using the second or third applicable configuration of Setter 403. For example, Setter 403 may be implemented by selecting a number of Additional Qubits 410 (or none) to be used, and repeatedly setting a highly-entangled state on all qubits of Dirty Auxiliary Input 411 and of the selected additional qubits. In some exemplary embodiments, the DM algorithm may comprise implementing the sixth applicable configuration by Setter 409, such as by setting a maximally-mixed state on Argument Input 414. In some exemplary embodiments, the DM algorithm may comprise Setter 407 setting expected states to Expected Input 413 (if exist), and Setter 405 setting zero states to Clean Auxiliary Input 412 (if exist). In some exemplary embodiments, after generating Circuit 402 using the DM simulator, the DM algorithm may comprise implementing the reduced density-matrix mechanism of the second inspection type, such as by calculating a reduced density-matrix for Dirty Auxiliary Output 415, Clean Auxiliary Output 416, or the like, and inspecting the states of the reduced density-matrices via Inspectors 423 and 424, to verify that the qubits are in zero state. In other cases, measurements may be used for the inspection. The Inverse Structure 404 may not be supported by the DM algorithm.

Another exemplary verification algorithm may comprise a selection of configurations of Testing Quantum Circuit 400 when utilizing a TN simulator (referred to as ‘the TN algorithm’), e.g., as follows:
1. Perform a contraction at Setter 403.
2. Perform a contraction at Setter 409.
3. Set expected states at Setters 405 and 407.
4. Implement Inverse Structure 404.
5. Perform a contraction mechanism for inspection.

In some exemplary embodiments, according to the TN algorithm, Setters 403 and 409 may comprise loop setters that comprise respective loop contractions, such as by setting a loop contraction between Dirty Auxiliary Input 411 and Dirty Auxiliary Output 415, setting a loop contraction between Argument Input 414 and Return Output 417, or the like. For example, the fifth applicable configuration may be applied to Setters 403 and 409. In some exemplary embodiments, the TN algorithm may comprise Setter 407 setting expected states to Expected Input 413 (if exist), and Setter 405 setting zero states to Clean Auxiliary Input 412 (if exist). In some exemplary embodiments, when utilizing a tensor network, the qubits manipulated by Circuit 402 may be represented by input and output vectors, which may include sub-indexes, and the circuits may be represented by linear matrices, inverse linear matrices, or the like. In some cases, the setters, inverse setters, and inspectors may or may not comprise loop contractions. Inverse Structure 404 may be implemented subsequently to Circuit 402, and the contraction mechanism of the third inspection type may be applied for inspecting the output states, such as by contracting inspectors with the zero state in case that they do not comprise a loop contraction. The inspectors may verify that the contraction mechanism applied to the network contracts the network to 2^{ARG+2·AUX}, wherein ARG is a number of argument qubits in Circuit 402 and AUX is a number of dirty auxiliary qubits in Circuit 402.

In some exemplary embodiments, any of the above algorithms may be implemented with empty sets, such as in case one of the input classifications is absent, in case a number of additional qubits is zero, or the like. In such cases, an operation associated with the empty set may not be performed. In some cases, although the algorithms were described using an ordered number of steps, any other order of steps may be implemented, they may be performed in parallel, or the like. In some cases, any other proper combinations of setter configurations, inspector configurations, utilization of the inverse structure, or the like, may be used as a verification algorithm. In some exemplary embodiments, proper combinations may comprise combinations that do not comprise contradictory settings, that are supported by the simulator that is being used, or the like.

In some exemplary embodiments, one or more additional verification algorithms may be defined with respect to scenarios in which only one type of auxiliary qubits are indicated: dirty or clean auxiliary qubits. In some exemplary embodiments, given a quantum circuit and a subset of qubits in the circuit that are indicated as clean auxiliary qubits, one or more configurations, or algorithms, of Testing Quantum Circuit 400 may be implemented, e.g., as follows.

An exemplary algorithm for verifying clean auxiliary qubits in a scenario with no indicated dirty auxiliary qubits, may be implemented using an SV simulator, e.g., as follows:
1. Set a zero state to the zero input qubits of the expected qubits, and to the clean auxiliary qubits.
2. Set a computational basis state for the argument qubits.
3. Simulate the circuit using an SV simulator.
4. Verify that the clean auxiliary qubits are still in zero state.
5. Repeat the process for all computational basis states.

In some exemplary embodiments, another exemplary algorithm for verifying clean auxiliary qubits in a scenario with no indicated dirty auxiliary qubits, may be implemented using an SV simulator, e.g., as follows:
1. Set a zero state to the zero input qubits of the expected qubits, and to the clean auxiliary qubits.
2. Set a highly-entangled random state to the argument qubits.
3. Simulate the circuit using an SV simulator.
4. Verify that the clean auxiliary qubits are still zero state.
5. Repeat the process randomly, until complying with a confidence threshold.

In some exemplary embodiments, another exemplary algorithm for verifying clean auxiliary qubits in a scenario with no indicated dirty auxiliary qubits, may be implemented using a DM simulator, e.g., as follows:
1. Set a zero state to the zero-input qubits of the expected input and to the clean auxiliary qubits.
2. Set a maximally mixed state to the argument qubits.
3. Simulate the circuit using a DM simulator.
4. Verify that the clean auxiliary qubits are still in zero state using a reduced density matrix.

In some exemplary embodiments, another exemplary algorithm for verifying clean auxiliary qubits in a scenario with no indicated dirty auxiliary qubits, may be implemented using a TN simulator, such as by generating a tensor network including Circuit 402 and Inverse Circuit 443, contracting the network, and verifying that the result is 2^{IN}, wherein IN denoted the quantity of input qubits. In some exemplary embodiments, the tensor network may simulate the circuit once, using a single set of inputs, while, for an increased confidence score, an inspection or sampling of the results, by contraction, may be performed multiple times.

In some exemplary embodiments, another exemplary algorithm for verifying clean auxiliary qubits in a scenario with no indicated dirty auxiliary qubits, may be implemented using a fault-tolerant quantum computer, e.g., as follows:
1. Set a zero state to the zero-input qubits of the expected input and to the clean auxiliary qubits.
2. Pair each argument qubit with an auxiliary qubit.
3. Set a maximally-entangled state on the pairs, thereby obtaining disjoint Bell-pairs.
4. Simulate the circuit on a quantum simulator such as a fault-tolerant quantum computer.
5. Verify that the clean auxiliary qubits are in zero state.
6. Optionally:
   Execute the inverse function.
   Measure the clean auxiliary qubits and verify that they are in zero state.
   Reverse the Bell-pairs on the argument qubits.
   Measure the argument qubits and the additional qubits, and verify that they are in zero state.
7. Repeat process until complying with a confidence threshold.

In some exemplary embodiments, an exemplary algorithm for verifying dirty auxiliary qubits in a scenario with no indicated clean auxiliary qubits, may be implemented using an SV simulator, e.g., as follows:
1. Set a zero state to the zero-input qubits of the expected qubits.
2. Select a computational basis state for the argument qubits and the dirty auxiliary qubits, and apply the states.
3. Simulate the circuit using an SV simulator.
4. Verify that the dirty auxiliary qubits are in a same state via a reduced density matrix.
5. Repeat process for all computational basis states.

In some exemplary embodiments, another exemplary algorithm for verifying dirty auxiliary qubits in a scenario with no indicated clean auxiliary qubits, may be implemented using an SV simulator, e.g., as follows:
1. Set a zero state to the zero-input qubits of the expected qubits.
2. Set a highly-entangled random state to the argument qubits and the dirty auxiliary qubits.
3. Simulate the circuit using an SV simulator.
4. Reverse the setters of the dirty auxiliary qubits.
5. Verify that the dirty auxiliary qubits are in zero state via a reduced density matrix.
6. Repeat the process randomly, until complying with a confidence threshold.

In some exemplary embodiments, another exemplary algorithm for verifying dirty auxiliary qubits in a scenario with no indicated clean auxiliary qubits, may be implemented using an DM simulator, e.g., as follows:
1. Set a zero state to the zero-input qubits.
2. Set a maximally-mixed state to the argument qubits.
3. Set a computational basis state on the dirty auxiliary qubits.
4. Simulate the circuit using a DM simulator.
5. Verify that the dirty auxiliary qubits are in the same state via a reduced density matrix.
6. Repeat the process for all computational basis states.

In some exemplary embodiments, another exemplary algorithm for verifying dirty auxiliary qubits in a scenario with no indicated clean auxiliary qubits, may be implemented using a DM simulator, e.g., as follows:
1. Set a zero state to the zero-input qubits.
2. Set a maximally mixed state to the argument qubits.
3. Set a highly-entangled random state to the dirty auxiliary qubits.
4. Simulate the circuit using a DM simulator.
5. Reverse the setters of the dirty auxiliary qubits.
6. Verify that the dirty auxiliary qubits are in zero state via a reduced density matrix.
7. Repeat the process using random highly-entangled states, until complying with a confidence threshold.

In some exemplary embodiments, another exemplary algorithm for verifying dirty auxiliary qubits in a scenario with no indicated clean auxiliary qubits, may be implemented using a DM simulator and additional qubits, e.g., as follows:
1. Set a zero state to the zero-input qubits.
2. Pair each dirty auxiliary qubit to a different additional qubit.
3. Set a maximally-entangled state on the pairs, thereby obtaining disjoint Bell-pairs.
4. Set a maximally-mixed state to the argument qubits.
5. Simulate the circuit using a DM simulator.
6. Reverse the Bell-pairs on the dirty auxiliary qubits.
7. Verify that the dirty auxiliary qubits and the additional qubits are in the zero state.

In some exemplary embodiments, another exemplary algorithm for verifying dirty auxiliary qubits in a scenario with no indicated clean auxiliary qubits, may be implemented using a TN simulator. In some exemplary embodiments, the algorithm may comprise simulating the circuit in a configuration that utilizes the inverse structure, Inverse Circuit 443, or the like, such as by generating a tensor network depicted by FIG. 5. In some exemplary embodiments, the simulation may be inspected by contracting the network of FIG. 5 and verifying that its result is 2^{IN+2·AUX}. In some exemplary embodiments, the tensor network may simulate the circuit once, using a single set of inputs. In some exemplary embodiments, for an increased confidence score, an inspection or sampling of the results, by contraction, may be performed multiple times.

In some exemplary embodiments, another exemplary algorithm for verifying dirty auxiliary qubits in a scenario with no indicated clean auxiliary qubits, may be implemented using a quantum simulator such as a fault-tolerant quantum computer, e.g., as follows:
1. Set a zero state to the zero-input qubits.
2. Pair a different additional qubit to each argument qubit and dirty auxiliary qubit.
3. Set a maximally-entangled state on the pairs, thereby obtaining disjoint Bell-pairs.
4. Execute the circuit on the fault-tolerant quantum computer.
5. Reverse the Bell-pairs on the dirty auxiliary qubits.
6. Measure the dirty auxiliary qubits and their coupled additional qubits, to check that they are in zero states.
7. Optionally:
   Pair each dirty auxiliary qubit to a different additional qubit
   Set a maximally-entangled state on the pairs.
   Execute the inverse circuit on the fault-tolerant quantum computer.
   Reverse the Bell-pairs on the dirty auxiliary qubits.
   Measure the dirty auxiliary qubits and their additional qubits, to verify that they are in zero states.
   Reverse the Bell-pairs on the argument qubits.
   Measure the argument qubits and their coupled additional qubits, to verify that they are in zero states.
8. Repeat process until complying with a confidence threshold.

Another technical problem dealt with by the disclosed subject matter is detecting auxiliary qubits in a quantum circuit. In some exemplary embodiments, it may be desired to identify, within a set of qubits of a function, a subset of auxiliary qubits, e.g., automatically.

Yet another technical problem dealt with by the disclosed subject matter is detecting auxiliary qubits in a quantum circuit, without obtaining indications of auxiliary qubits (e.g., role indications). In some exemplary embodiments, it may be desired to detect auxiliary qubits without obtaining an indication indicating that they are auxiliary qubits. In some exemplary embodiments, it may be challenging to detect auxiliary qubits without a role indication. In some exemplary embodiments, it may be desired to test, for a known or an unknown circuit, function, program, or the like, which qubits thereof are auxiliary qubits.

A naïve solution may comprise attempting to verify all subgroups of the qubits, such as by applying a verification algorithm on every subgroup of qubits. In some cases, each subset of qubits may be analyzed as potentially constituting auxiliary qubits, and an auxiliary verification test may be applied to verify or refute the allegation. In some cases, the naïve solution may have one or more drawbacks. For example, iterating over every subset of qubits may be resource consuming. It may be desired to overcome such drawbacks.

One technical solution provided by the disclosed subject matter may include detecting dirty auxiliary qubits of the inspected circuit that are robust, using one or more auxiliary verification tests.

In some exemplary embodiments, qubits may be considered to be ‘robust’ in case they are dirty auxiliary qubits, and in case they uphold the auxiliary property regardless of proper or improper states of other qubits. In some exemplary embodiments, qubits that restore their original state after being manipulated by the quantum circuit, for any states of the remaining qubits, including improper states, may be robust qubits. In some exemplary embodiments, improper states of the remaining qubits may comprise states that are not proper, for example, setting an unknown state to clean auxiliary states, setting garbage or random states to expected inputs, or the like. For example, in case a dirty auxiliary qubit is uncomputed at an end of a quantum circuit regardless of the expected input qubits and the clean auxiliary qubits, the qubit may be robust. It is noted, however, that in case an expected input such as a zero input qubit is not provided in its expected state, this may not harm the robust qubits, although it may harm the functionality of the circuit.

In some exemplary embodiments, in order to detect robust qubits, one or more qubits that are provided to an inspected quantum circuit may be tested independently, using an auxiliary verification test, such as according to a defined order, according to a random order, or the like. For example, any verification algorithm that was described with respect to FIGS. 4 and 5, including any proper combination of setter configurations, inspector types, or the like, may be applied or executed iteratively for each qubit independently. In some exemplary embodiments, in order to utilize verification algorithms, role indications may be necessary. In some exemplary embodiments, utilizing the verification algorithms may comprise generating role indications to include an indication that the currently inspected qubit is a dirty auxiliary qubit, and that the remaining qubits are argument qubits. In some exemplary embodiments, the verification algorithms may be provided with the generated role indications, the inspected circuit, and the plurality of qubits manipulated by the circuit. In some exemplary embodiments, the auxiliary verification test may, in response, execute a corresponding testing quantum circuit, and determine, based thereon, whether or not the inspected qubit upholds auxiliary properties. Every qubit that is verified by the auxiliary verification test, may be marked as an auxiliary qubit, added to a generated list or group of detected auxiliary qubits, or the like.

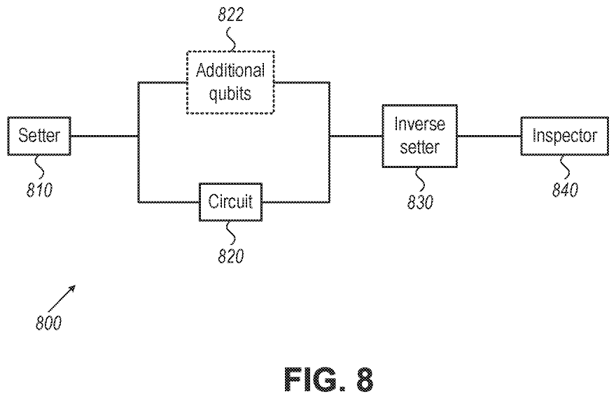

Another technical solution provided by the disclosed subject matter may include obtaining or generating a detecting quantum circuit such as Detecting Circuit 800 of FIG. 8, and implementing one or more detection or identification algorithms therein. In some exemplary embodiments, identification algorithms may be configured to obtain a circuit that manipulated a plurality of qubits, and identify or detect which robust qubits therein that comply with one or more auxiliary properties without using role indications. In some exemplary embodiments, one or more robust auxiliary qubits that comply with the auxiliary property may be identified in the plurality of qubits, and added to a generated list or group of detected auxiliary qubits, marked as auxiliary qubits, or the like. For example, qubits may comply with an auxiliary property in case they are provided to the quantum circuit in a certain state, and are outputted from the quantum circuit in the certain state regardless of the states of the remaining qubits

In some exemplary embodiments, the identification algorithms may be configured to set one or more initial states to the qubits using one or more setters, and simulate the circuit using the initial states. In some cases, the one or more setters may be operatively coupled to the plurality of qubits before being manipulated by the quantum circuit, while one or more inverse setters may be operatively coupled to the plurality of qubits after being manipulated by the quantum circuit, thereby reversing the initial states. In case that an outputted qubit is outputted in a zero state, this may indicate that its state was restored by the circuit, and that the qubit is potentially an auxiliary qubit.

One technical effect provided by the disclosed subject matter is enabling to identify auxiliary qubits in an unknown circuit. Auxiliary qubits may be identified without obtaining role indications of the auxiliary qubits (e.g., as a user-provided indication of qubit identities or as any other indication), and without iteratively checking each potential subgroup of the plurality of qubits individually.

Another technical effect provided by the disclosed subject matter is enabling to detect robust auxiliary qubits. For example, robust auxiliary qubits may comprise dirty auxiliary qubits which are uncomputed at an end of a circuit regardless of the states of the expected input or the clean auxiliary input. In case that a circuit has no expected input qubits nor clean auxiliary qubits, any qubit thereof may be considered to be robust auxiliary qubits with respect to the circuit.

Yet another technical effect provided by the disclosed subject matter is detecting auxiliary qubits, and utilizing to detect functional blocks, metadata, objectives, or the like, or a circuit, thereby providing a reverse engineering capability of reconstructing the circuit.

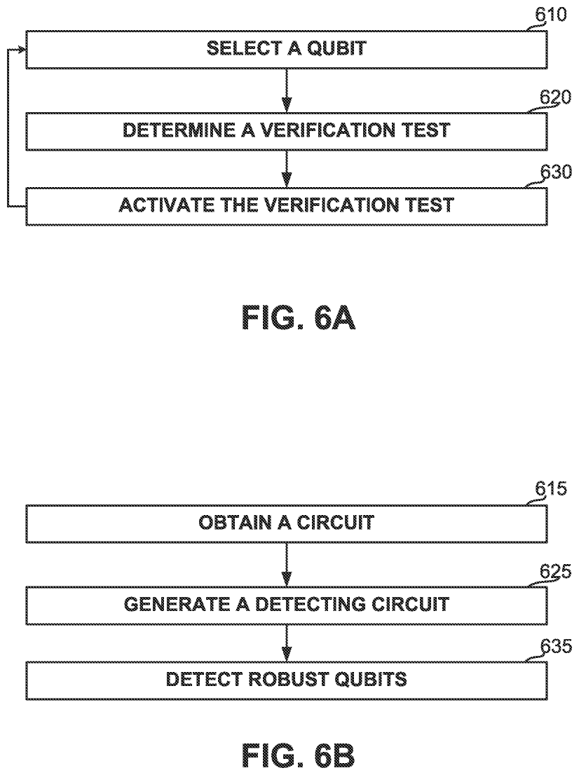

Referring now to FIG. 6A, showing an exemplary flowchart diagram of a method, in accordance with some exemplary embodiments of the disclosed subject matter.

On Step 610, an input qubit of a circuit may be selected, e.g., iteratively for one or more qubits, for the plurality of qubits, or the like. For example, the circuit may be unknown, and qubits thereof may be selected for verification according to a defined order, according to a random order, sequentially, iteratively, or the like, until all qubits or a subgroup thereof are selected exactly once. It is noted that a qubit may refer to an individual qubit, or to a set of qubits that is processed together.

On Step 620, a verification test may be selected or determined for the input qubit. For example, a test may be selected in case it matches available resources such as a type of simulator that is available. In some exemplary embodiments, the verification test may comprise any algorithm described with respect to FIGS. 4 and 5, any proper combination of setting of components within the testing quantum circuit of FIGS. 4 and 5, or the like.

On Step 630, the determined verification test may be activated, executed, or the like, for the input qubit, such as by providing the verification test with the circuit, generated role indications, or the like. For example, the role indications may be generated to indicate that the input qubit is a dirty auxiliary qubit, and that the remaining qubits are argument qubits. In some exemplary embodiments, every qubit that was successfully verified, may constitute a robust qubit, and may be listed or marked as such.

In some exemplary embodiments, Step 610-630 may be performed iteratively, for each qubit that is obtained or manipulated by the inspected circuit, for a portion thereof, or the like, until each inspected qubit is tested once.

Referring now to FIG. 6B, showing an exemplary flowchart diagram of a method, in accordance with some exemplary embodiments of the disclosed subject matter.

On Step 615, an unknown circuit may be obtained. In some exemplary embodiments, the unknown circuit may manipulate a plurality of qubits. In some exemplary embodiments, the unknown circuit may be obtained without role indications of its qubits.

On Step 625, a detecting quantum circuit may be generated for detecting robust qubits within the plurality of qubits that are manipulated by the unknown circuit. In some exemplary embodiments, the detecting circuit may be generated to comprise the unknown circuit, along with detecting components such as one or more setters, additional qubits, inverse setters, inspectors, or the like.

In some exemplary embodiments, the detecting circuit may be configured to set initial states of qubits from the unknown circuit, e.g., using one or more setters. In some exemplary embodiments, the detecting circuit may simulate the quantum circuit using one or more simulators. In some exemplary embodiments, the detecting circuit may be configured to reverse the initial states of qubits outputted from the quantum circuit, and use one or more inspectors to inspect the final states, to contract the network, or the like. In some cases, one or more additional qubits that are external to the quantum circuit may be included in the detecting circuit. In some exemplary embodiments, the additional qubits may refer to qubits that are part of the detecting circuit but are not part of the inspected circuit, and may be used to represent cooperative states together with the input qubits of the unknown circuit.

For example, each qubit may be paired with a different, unique, additional qubit, and maximally-entangled states may be applied on each pair. The unknown circuit may be generated or simulated using an SV simulator, a DM simulator, a TN simulator, a quantum simulator, or the like, e.g., by the detecting circuit, together with the detecting circuit, or the like. An inverse setter may be applied to the results from the simulation, and qubits outputted therefrom may be inspected to identify qubits that are in zero state as potential robust qubits.

As another example, a computational basis may be selected. One or more setters may select computational basis states as initial states for the qubits, and set them on the qubits of the unknown circuit. The circuit may be generated or simulated using an SV simulator, a DM simulator, a TN simulator, a quantum simulator, or the like, and inverse setters may be applied to the qubits outputted from the quantum circuit, e.g., to reverse or nullify the initial states. The results may be inspected by one or more inspectors or contractions, to identify zero state qubits. According to this example, the process may be repeated for all computational basis states, to verify that none of the computational bases violate the robust properties of candidate qubits. For example, each iteration may comprise generating the unknown circuit with different computational basis states, until all of the computational basis states were tested. In case a final state of a qubit for all the applied computational basis states is the zero state, the qubit may be determined to be an auxiliary qubit, a robust qubit, or the like. In some exemplary embodiments, qubits may be marked in case their final state is zero in each iteration, and the qubits may be determined to be robust in case they are marked in all iterations. In some cases, each iteration may only mark a qubit in case it was also marked in a previous iteration (besides the initial iteration). This way, marks of two iterations may be stored instead of storing marks from all iterations.

On Step 635, one or more robust qubits, including dirty auxiliary qubits, may be detected based on the detecting circuit. In some exemplary embodiments, results from the circuit simulation may be inspected, measured, or the like, by one or more inspectors of the detecting circuit, by one or more contractions, or the like, such as in order to detect qubits that are outputted with a zero state for any states of the remaining qubits. In some exemplary embodiments, the inspectors may be configured to inspect final states of the plurality of qubits that are outputted from inverse setters. In some exemplary embodiments, the inspectors may comprise contractions of TN networks that include the detecting circuit. In some cases, measurements of the qubit states may be performed multiple times, such as until complying with a confidence score of the measured states (indicating that the measured states are statistically significant). In other cases, measurements may be performed once.

In some cases, such as in case that a simulator that is used to simulate the circuit is not a quantum simulator (e.g., a fault-tolerant quantum computer), qubits states may be inspected by calculating reduced density matrices of the qubits, and identifying qubits that are in the zero state using the reduced density matrices. In some cases, measurements may be performed to inspect qubit states.

In some exemplary embodiments, the representation of the quantum circuit may be compiled based on the detected robust qubits, e.g., while taking into account that the robust qubits comprise dirty auxiliary qubits that comply with the auxiliary property.

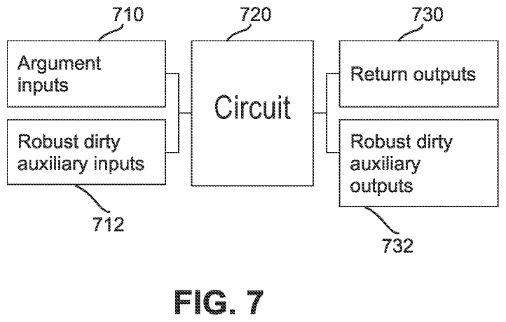

Referring now to FIG. 7, depicting exemplary inputs and outputs characterizations of a circuit, in accordance with some exemplary embodiments of the disclosed subject matter.

In some exemplary embodiments, inputs to a quantum circuit, such as Circuit 720, may comprise Argument Inputs 710 and Robust Dirty Auxiliary Inputs 712. In some exemplary embodiments, Argument Inputs 710 may comprise qubits that are not robust dirty auxiliary qubits. In some cases, Argument Inputs 710 may comprise zero-input qubits, clean auxiliary qubits, expected input, or the like, which may not be detectable when setting thereto improper states. For example, when setting non-zero values to clean auxiliary qubits, the state may or may not be retained by the circuit. In some exemplary embodiments, Robust Dirty Auxiliary Inputs 712 may comprise dirty auxiliary qubits that are robust to proper and improper states of the remaining input qubits. Such qubits may be detected using the disclosed subject matter.

In some exemplary embodiments, outputs from Circuit 720 may comprise Return Outputs 730 and Robust Dirty Auxiliary Outputs 732. In some exemplary embodiments, Return Outputs 730 may comprise Argument Inputs 710 when outputted from Circuit 720. In some exemplary embodiments, Robust Dirty Auxiliary Outputs 732 may comprise the qubits of Robust Dirty Auxiliary Inputs 712 when outputted from Circuit 720.

It is noted that any characterization class of qubits may comprise an empty set, if none were provided or detected.

Referring now to FIG. 8 showing an exemplary detecting quantum circuit, in accordance with some exemplary embodiments of the disclosed subject matter.

In some exemplary embodiments, Detecting Circuit 800 may comprise a detecting quantum circuit for detecting robust auxiliary qubit with respect to an inspected circuit, e.g., Circuit 820. For example, the method of FIG. 6B may be implemented by generating Detecting Circuit 800.

In some exemplary embodiments, Detecting Circuit 800 may comprise one or more setters such as Setter 810, which may comprise one or more setters that may be operatively coupled to the input qubits that are manipulated by Circuit 820. In some cases, Setter 810 may in some cases be operatively coupled to Additional Qubits 822 (if not an empty set), which may be external to Circuit 820. For example, Setter 810 may utilize Additional Qubits 822 to pair a unique additional qubit to each qubit of Circuit 820, and apply a Maximally-entangled state on each qubit couple, thereby obtaining Bell-pairs. Circuit 820 may be simulated, using one or more simulators, thereby manipulating the Bell-pairs. Inverse Setter 830 may reverse the Bell-pairs on the qubits of Circuit 820, and Inspector 840 may measure the results using one or more measurements, a reduced density-matrix, or the like, to verify that they are in zero state. In some cases, the setters, inverse setters, and additional qubits of FIG. 8 may correspond to respective setters, inverse setters, and additional qubits of FIGS. 4 and 5.

In some exemplary embodiments, an exemplary detection algorithm using a quantum simulator such as a fault-tolerant quantum computer and additional qubits may be as follows:
1. Pair each input qubit of Circuit 820 with a different additional qubit of Additional Qubits 822.
2. Prepare a maximally-entangled state on the qubit pairs, thereby obtaining disjoint Bell-pairs.
3. Simulate the circuit using the quantum simulator.
4. Reverse the Bell-pairs on the qubits of the circuit using Inverse Setter 830.
5. Measure the qubit pairs to determine whether they are in zero state.
6. Mark every pair of qubits that are both in zero state.
7. Repeat process until reaching a confidence threshold, and determine that a qubit is an auxiliary qubit if it has a zero state after every iteration.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining a representation of a quantum circuit, wherein the quantum circuit manipulates a plurality of qubits over a plurality of cycles, wherein role indications of the plurality of qubits are not available; and
detecting one or more robust qubits in the plurality of qubits, wherein each qubit of the one or more robust qubits comprises a dirty auxiliary qubit that is robust to quantum states of remaining qubits from the plurality of qubits, wherein said detecting comprises:
applying one or more initial states to the plurality of qubits using one or more quantum state setters,
simulating the quantum circuit using a simulator, and
inspecting states of the plurality of qubits from said simulating.

2. The method of claim 1, wherein said detecting comprises applying one or more inverse quantum state setters, wherein the one or more quantum state setters are operatively coupled to the plurality of qubits before being manipulated by the quantum circuit, wherein the one or more inverse quantum state setters are operatively coupled to the plurality of qubits after being manipulated by the quantum circuit, wherein the one or more inverse quantum state setters are configured to reverse the one or more initial states.

3. The method of claim 1, wherein said detecting comprises generating a detecting quantum circuit, wherein the detecting quantum circuit comprises one or more additional qubits that are external of the quantum circuit, wherein the plurality of qubits excludes the one or more additional qubits.

4. The method of claim 3, wherein said detecting comprises:
pairing the plurality of qubits to the one or more additional qubits, respectively, thereby obtaining a plurality of disjoint qubit pairs, and
applying, using the one or more quantum state setters, a maximally-entangled state to each of the plurality of qubit pairs.

5. The method of claim 1, wherein said detecting comprises, iteratively:
selecting computational basis states for the plurality of qubits, respectively, and
applying, by the one or more quantum state setters, the computational basis states to each of the plurality of qubit pairs.

6. The method of claim 1, wherein said detecting comprises generating a testing quantum circuit, wherein the testing quantum circuit is configured to obtain the quantum circuit and the role indications, and to verify unverified qubits that are indicated by the role indications as clean or dirty auxiliary qubits, wherein the testing quantum circuit is configured to perform said simulating and said inspecting.

7. The method of claim 6 comprising iteratively executing the testing quantum circuit for one or more qubits of the plurality of qubits, wherein, in each iteration, the role indications are generated and provided to the testing quantum circuit by indicating that an inspected qubit of the one or more qubits is a dirty auxiliary qubit and that the remaining qubits of the plurality of qubits are argument qubits.

8. The method of claim 1, wherein said inspecting comprises utilizing one of: a reduced density matrix and measurements.

9. The method of claim 1 further comprising compiling the representation of the quantum circuit based on said detecting the one or more robust qubits.

10. The method of claim 1, wherein said identifying is performed without iteratively checking each potential subgroup of the plurality of qubits individually.

11. The method of claim 1, wherein the role indications comprise one or more auxiliary qubit indications indicating one or more unverified qubits within the plurality of qubits of the quantum circuit.

12. The method of claim 1, wherein a qubit of the plurality of qubits is robust to the quantum states of the remaining qubits in case an auxiliary property is complied with by the qubit for each initial state of the plurality of qubits.

13. An apparatus comprising a processor and coupled memory, said processor being adapted to:
obtain a representation of a quantum circuit, wherein the quantum circuit manipulates a plurality of qubits over a plurality of cycles, wherein role indications of the plurality of qubits are not available; and
detect one or more robust qubits in the plurality of qubits, wherein each qubit of the one or more robust qubits comprises a dirty auxiliary qubit that is robust to quantum states of remaining qubits from the plurality of qubits, wherein said detecting comprises:
applying one or more initial states to the plurality of qubits using one or more quantum state setters,
simulating the quantum circuit using a simulator, and
inspecting states of the plurality of qubits from said simulating.

14. The apparatus of claim 13, wherein said detecting comprises applying one or more inverse quantum state setters, wherein the one or more quantum state setters are operatively coupled to the plurality of qubits before being manipulated by the quantum circuit, wherein the one or more inverse quantum state setters are operatively coupled to the plurality of qubits after being manipulated by the quantum circuit, wherein the one or more inverse quantum state setters are configured to reverse the one or more initial states.

15. The apparatus of claim 13, wherein said detecting comprises generating a detecting quantum circuit, wherein the detecting quantum circuit is generated to comprise one or more additional qubits that are external of the quantum circuit, wherein the plurality of qubits excludes the one or more additional qubits.

16. The apparatus of claim 15, wherein said detecting comprises:
pairing the plurality of qubits to the one or more additional qubits, respectively, thereby obtaining a plurality of disjoint qubit pairs, and
applying, using the one or more quantum state setters, a maximally-entangled state to each of the plurality of qubit pairs.

17. The apparatus of claim 13, wherein said detecting comprises, iteratively:
selecting computational basis states for the plurality of qubits, respectively, and
applying, by the one or more quantum state setters, the computational basis states to each of the plurality of qubit pairs.

18. The apparatus of claim 13, wherein said detecting comprises generating a testing quantum circuit, wherein the testing quantum circuit is configured to obtain the quantum circuit and the role indications, and to verify unverified qubits that are indicated by the role indications as clean or dirty auxiliary qubits, wherein the testing quantum circuit is configured to perform said simulating and said inspecting, wherein the processor is further adapted to iteratively execute the testing quantum circuit for one or more qubits of the plurality of qubits, wherein, in each iteration, the role indications are provided to the testing quantum circuit by indicating that an inspected qubit of the one or more qubits is a dirty auxiliary qubit and that the remaining qubits of the plurality of qubits are argument qubits.

19. The apparatus of claim 13, wherein the processor is further adapted to compile the representation of the quantum circuit based on said detecting the one or more robust qubits.

20. A computer program product comprising a non-transitory computer readable medium retaining program instructions, which program instructions, when read by a processor, cause the processor to:
obtain a representation of a quantum circuit, wherein the quantum circuit manipulates a plurality of qubits over a plurality of cycles, wherein role indications of the plurality of qubits are not available; and
detect one or more robust qubits in the plurality of qubits, wherein each qubit of the one or more robust qubits comprises a dirty auxiliary qubit that is robust to quantum states of remaining qubits from the plurality of qubits, wherein said detecting comprises:
applying one or more initial states to the plurality of qubits using one or more quantum state setters,
simulating the quantum circuit using a simulator, and
inspecting states of the plurality of qubits from said simulating.
